(19) United States
(12) Patent Application Publication
(10) Pub. No.: US 2004/0044688 A1
(43) Pub. Date: Mar. 4, 2004

(54) Patent asset management systems and methods

(76) Inventors: John Jason Brudz, Bolton, CT (US); Marc Scott Rubel, North Haven, CT (US); Christopher Taussig Graves, Canton, CT (US)

Correspondence Address: John S. Beulick, Armstrong Teasdale LLP, One Metropolitan Sq., Suite 2600, St. Louis, MO, 63102, US

(21) Appl. No.: 10/232,874

(22) Filed: Aug. 30, 2002

(51) Int. Cl. G06F 7/00

(52) U.S. Cl. 707/104.1

(57) ABSTRACT

A method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing PA information in response to an inquiry, and providing a bonus module for tracking at least one of bonuses and awards assigned to each inventor.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to patent assets, and more particularly, to systems and methods for managing patent applications and issued patents.

Patent organizations for entities such as multinational corporations may manage thousands, and possibly tens of thousands, of patent applications and patents. For each patent application and patent, certain actions typically must be taken over the course of any given year. For example, maintenance fees or annuities may come due in an issued patent, or foreign counterpart applications may be due for filing in a pending patent application. Commercially available docketing systems often are utilized in managing such assets, and particularly, in identifying due dates for matters such as maintenance fees, annuities, and other submissions. Failure to meet a particular due date can result in having to pay extra fees in extensions to the appropriate patent authorities, or possibly even in a loss of patent rights.

Typical users of a patent docketing system include in-house patent attorneys who are employees of the entity, outside patent attorneys who are not employees of the entity but work on patent matters for the entity, and docket clerks and administrative personnel. There may be fifty, or possibly one hundred or more users who require concurrent access to the docketing system in managing the patent assets.

In addition to the complexity due to the extent of patent assets that may be owned by an entity, and the capacity to support numerous concurrent users, most entities with patent assets already have patent docketing systems in place. The users are familiar with the interfaces and processes associated with such systems, and are not necessarily interested in losing the benefit of experience that has been gained over many years in working with a particular system. Such systems, however, may not provide a centralized robust web-based environment that facilitates access to patent asset information anytime or anywhere. In addition, the systems may not be scalable and may not integrate with other patent related systems (e.g., collaboration tools, project management systems, document management systems, third party databases, and e-mail). Further, such systems may not provide ad-hoc reporting capabilities using a standard tool such as business objects or may not provide flexible reporting and searching capabilities to retrieve data in different groupings.

### BRIEF SUMMARY OF THE INVENTION

In one aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing PA information in response to an inquiry, and providing a bonus module for tracking at least one of bonuses and awards assigned to each inventor.

In another aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing PA information in response to an inquiry, and providing a bonus module for tracking at least one of bonuses and awards assigned to each inventor at a plurality of stages during a patent prosecution including at least one of a disclosure filing, a U.S. patent application filing, a foreign patent application filing, an allowance of a patent application, and an issuance of a patent.

In another aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing PA information in response to an inquiry, and providing at least one report relating to PA information on a multi-level basis to a predesignated party. The multi-level basis includes a plurality of levels from within the business entity including at least one of an individual patent application basis, a product basis, a technology basis, a business basis, a division basis, and a company basis.

In another aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, and providing PA information in response to an inquiry on a multi-level basis selected by a user. The multi-level basis includes a plurality of levels from within the business entity including at least one of an individual patent application basis, a product basis, a technology basis, a business basis, a division basis, and a company basis.

In another aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing PA information in response to an inquiry, transmitting at least one report relating to PA information to a predesignated party, and providing a budget module for managing cost information relating to the business entity's patent assets.

In another aspect, a method for managing patent asset (PA) information for a business entity using a server system coupled to a centralized database and at least one client system is provided. The method includes receiving at the server system PA information from the client system, storing PA information received at the server system in the centralized database, tracking PA information stored in the centralized database, updating the centralized database periodically with newly received PA information to maintain PA information, providing export controls to restrict a user's access to only dockets assigned to the user and to restrict a user's access to only specific information included in a docket assigned to the user, and providing PA information in response to an inquiry from a user subject to the export controls.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, provide PA information in response to an inquiry, and provide a bonus module for tracking at least one of bonuses and awards assigned to each inventor.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, provide PA information in response to an inquiry, and provide a bonus module to store, track, and process at least one of bonuses and awards assigned to each inventor at a plurality of stages during a patent prosecution including at least one of a disclosure filing, a U.S. patent application filing, a foreign patent application filing, an allowance of a patent application, and an issuance of a patent.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, provide PA information in response to an inquiry, and provide at least one report relating to PA information on a multi-level basis to a predesignated party. The multi-level basis includes a plurality of levels from within said business entity including at least one of an individual patent application basis, a product basis, a technology basis, a business basis, a division basis, and a company basis.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, and provide PA information in response to an inquiry on a multi-level basis selected by a user. The multi-level basis includes a plurality of levels from within said business entity including at least one of an individual patent application basis, a product basis, a technology basis, a business basis, a division basis, and a company basis.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, and provide PA information in response to an inquiry, transmit at least one report relating to PA information to a predesignated party, and provide a budget module for managing cost information relating to the business entity's patent assets.

In another aspect, a network based system for managing patent asset (PA) information is provided. The system includes a client system having a browser, a centralized database for storing information, and a server system configured to be coupled to the client system and the database. The server system is further configured to receive PA information from the client system, store PA information in the centralized database, track PA information, update the centralized database periodically with newly received PA information to maintain PA information, provide export controls to restrict a user's access to only dockets assigned to the user and to restrict a user's access to only specific information included in a docket assigned to the user, and provide PA information in response to an inquiry from a user subject to the export controls.

In another aspect, a computer program embodied on a computer readable medium for managing patent asset (PA) information is provided. The program includes a code segment that receives PA information and then maintains a database by adding, deleting and updating PA information, and prompts a user to at least one of create a docket, edit a docket, add a filing, edit a filing, add an action, and edit an action. The code segment then provides users with access to PA information, tracks PA information stored within the database, provides PA information in response to an inquiry by a user, provides a schedule of upcoming tasks relating to PA information, provides at least one report relating to PA information to a predesignated party, and tracks at least one of bonuses and awards assigned to each inventor.

### BRIEF DESCRIPTION OF THE DRAWINGS

FIG. 1 is block diagram of an example system architecture of a Patent Asset Coordination System (PACS).

FIG. 2 is an expanded block diagram of an example embodiment of a server architecture of a PACS.

FIG. 3 illustrates an example configuration of a database within the database server of the server system including other related server components.

FIG. 4 is a flow chart illustrating example processes utilized by the PACS.

FIG. 5 is an example embodiment of a user interface displaying a home page in the PACS.

FIG. 6 is an example embodiment of a user interface displaying a create a new docket page in the PACS.

FIG. 7 is an example embodiment of a user interface displaying an edit docket details page in the PACS.

FIG. 8 is an example embodiment of a user interface displaying a docket details page in the PACS.

FIG. 9 is an example embodiment of a user interface displaying an add U.S. filing page in the PACS.

FIG. 10 FIG. 5 is an example embodiment of a user interface displaying an edit U.S. filing page in the PACS.

FIG. 11 is an example embodiment of a user interface displaying a filings detail page in the PACS.

FIG. 12 is an example embodiment of a user interface displaying an international filing entry page in the PACS.

FIG. 13 is an example embodiment of a user interface displaying an edit international filing entry page in the PACS.

FIG. 14 is an example embodiment of a user interface displaying an international filing details for a specific docket in the PACS.

FIG. 15 is an example embodiment of a user interface displaying a new filing action page for a specific docket in the PACS.

FIG. 16 is an example embodiment of a user interface displaying an action details page for a specific docket in the PACS.

FIG. 17 is an example embodiment of a user interface displaying an edit actions page for a specific docket in the PACS.

FIG. 18 is an example embodiment of a user interface displaying a close out actions page for a specific docket in the PACS.

FIG. 19 is an example embodiment of a user interface displaying an attorney docket due report input page in the PACS.

FIG. 20 is an example embodiment of a user interface displaying an attorney docket due report output page in the PACS.

FIG. 21 is an example embodiment of a user interface displaying an inventor execution date entry page in the PACS.

FIG. 22 is an example embodiment of a user interface displaying a contact master-add page in the PACS.

FIG. 23 is an example embodiment of a user interface displaying an edit contact information page in the PACS.

FIG. 24 is an example embodiment of a user interface displaying an awards detail page in the PACS.

FIG. 25 is an example embodiment of a user interface displaying an inventor awards details and pending awards page in the PACS.

FIG. 26 is an example embodiment of a user interface displaying an advanced docket search input page in the PACS.

FIG. 27 is an example embodiment of a user interface displaying an advanced docket search results page in the PACS.

FIG. 28 is an example embodiment of a user interface displaying a maintenance tables page in the PACS.

### DETAILED DESCRIPTION OF THE INVENTION

Set forth below is a description of fully integrated and online systems and methods for managing patent assets and Patent Asset (PA) information through a Patent Asset Coordination System (“PACS”). The methods and systems are sometimes described as being practiced utilizing an internet or the internet. An internet and the internet, however, are examples of communication networks, and the methods and systems can be practiced in connection with many other local area and wide area networks. Therefore, the methods and systems are not limited to a practice of using an internet and/or the internet, and can be practiced using many other networks.

PA information includes at least one of a docket number, a docket date, an originating business, a technology group, an originating department, an owning business, a parent docket, an alternate docket number, a patent application title, a product/part/service description, an abstract, inventor information, prosecuting attorney information, contact information, disclosure status, a prosecution priority rating, inventor assignment information, foreign filing information, U.S. Patent and Trademark Office (USPTO) Serial Number, Patent Number awarded from USPTO, Group Art Unit data, recorded date, prosecution tasks, prosecution dates, patent expiration dates, and other patent related information.

A technical effect produced by the system includes managing PA information for a business entity. The PA information can be retrieved at different levels, such as a filing level, docket level, by a lab/technology group, an originating lab/technology group, an originating business, an owning business, a foreign filing sponsor, and a funding business. Other technical effects produced by the system include providing centralized and conformed PA information to multiple users within a business entity and authorized users outside the business entity, scheduling and managing patent filings and patent related actions, and generating a plurality of reports relating to PA information. Additionally, the PACS enables a business entity to manage PA information including patent related filings and actions for both U.S. filed patent applications and foreign filed patent applications.

The systems and methods are not limited to the specific embodiments described herein. Components of each system can be practiced independently and separately from the other components and each method can be practiced independently and separately from the other methods described herein. Each component and method can be used in combination with other components and other methods.

Generally, and with respect to an example embodiment of the PACS described below in detail, a graphical user interface (GUI) is provided to quickly acclimate users to the system. In addition, and in an example embodiment, an efficient database is integrated into the system, which facilitates ensuring that the data is safe from possible risk factors.

The functionality is embedded in an application layer component, such as component object model (COM) components and a firewall is provided for security. The firewall is configured to authenticate requests from a web server and facilitates preventing unauthorized access. The applications have various authorization levels, which are controlled by an administrator. Each user has a predefined username and password, which allows each user to access the system and facilitates preventing unauthorized use.

The systems and methods also record and track the various stages of an invention from conception through subsequent processes, such as domestic and foreign patent procurement and maintenance or publication.

Easy to use reference and lookup values are provided to simplify and conform the data entry process. Search options are provided to allow the user to retrieve data from the system. Predefined searches and reporting capabilities allow the user to generate very specific output on the user's computer screen and in the form of reports. Various reports at all levels can be generated by the system. For user convenience, the reports accept a plurality of runtime parameters and a plurality of criteria, which results in providing the desired output consistent with user requests. The system also facilitates regular and easy to use incremental data backup and archiving features.

Set forth below are a description of a typical patent asset life cycle as well as a description of an example system architecture, example system processes, example graphical user interfaces, and example reports.

Life Cycle of a Typical Patent Asset

Within a business entity, a typical invention is conceived by employees in an operating business or at a research center. Inventions are conceived, for example, by engineers and other individuals, who are employed by, or under contract with, the business entity. An inventor completes an invention disclosure form, in accordance with the policies and practices of the inventor's business, and forwards the disclosure form to the patent department within that business.

A Patent Docket Administrator (“PDA”) for that business will begin to keep a record of actions pertaining to that invention. This record is commonly referred to as a “Docket” and the process of recording these actions is referred to as “Docketing.” When a new docket is opened for an invention, a unique docket number is assigned, which identifies the invention for its entire lifecycle.

After the invention disclosure is forwarded to the PDA and a docket is opened, the invention is reviewed by a board of technologists and attorneys within the business with the purpose of deciding whether to file a patent application for the invention, publish the invention or keep the invention as a trade secret. If an invention is “Rated to File,” it is approved for filing and a patent application is prepared. The patent application may be prepared by in-house patent attorneys or by outside patent attorneys under contract with the corporation.

The patent application is filed in a patent office for governmental review and examination. The period between filing and issuance of a patent is referred to as “prosecution.” During prosecution, many communications between and among the inventor, inside attorneys, outside attorneys, PDA's, management and the patent office typically take place. Many of these communications are docketed in a patent docketing system.

After filing the first patent application, and preferably within six months of the first filing, the responsible business must determine if it, or possibly another business, requires patent protection in countries other than the country of the original filing. If a business determines that foreign filing is warranted, foreign filing instructions are provided to the docket and the docket is foreign filed. For example, certain business entities have an international patent operation (IPO) that manages foreign filing. The IPO submits, either directly or through agents, corresponding applications in a patent office for each foreign jurisdiction in which the business has elected to file.

After the patent has issued, maintenance fees are periodically paid to the government granting the patent. In the case of U.S. patents, for example, the originating business or the business to which the invention has been transferred pays the fees. In the case of foreign patents, the fees are administered and paid by a third party service bureau and billed back to the individual businesses by the IPO.

Example System Architecture

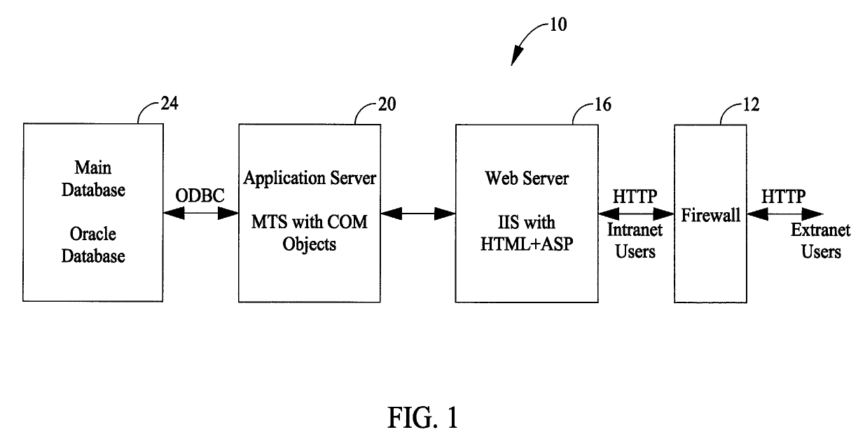

FIG. 1 is a block diagram of a Patent Asset Coordination System (PACS) 10 including a firewall 12 to secure the network on the Internet. Firewall 12 authenticates requests for a web server 16 and prevents any unauthorized access to the corporate network. The access to the corporate network can be controlled on the basis of IP addresses of the web servers that contain the Extranet web site.

PACS 10 includes web server 16, which is illustrated as a Microsoft IIS web server that receives all HTTP requests originating from the browsers. (The Microsoft IIS web server is manufactured by Microsoft Corporation, Redmond, Washington.) In response, web server 16 renders static web pages or dynamically generated pages or a combination of both. The dynamic pages are generated by using server-side scripting. The server-side scripts may in turn make calls to business components residing on an application server 20. Web server 16 implements the presentation logic for the application as well as the security for the application.

Application server 20 is illustrated as a Microsoft Transaction Server (MTS) that invokes and manages the business logic components. (The Microsoft Transaction Server is manufactured by Microsoft Corporation, Redmond, Washington.) These components implement the business logic, are hosted on MTS, and interact with the databases through the open system protocols such as Open Database Connectivity (ODBC), ActiveX® Data Object/Remote Data Object (ADO/RDO) (ActiveX is a registered trademark of Microsoft Corporation, Redmond, Washington). Application server 20 manages the components so as to provide scalability, load balancing, and object management.

PACS 10 also includes a main database 24, which is an Oracle® database (Oracle is a registered trademark of Oracle Corporation, Redwood City, Calif.). Database 24 stores all PA information, including business information related to patent assets.

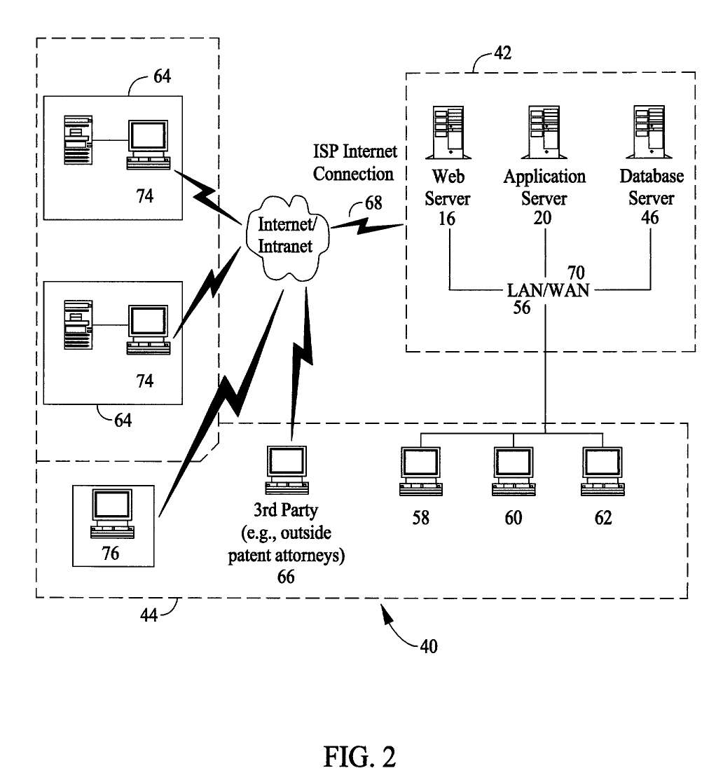

FIG. 2 is an expanded block diagram of an example embodiment of a server architecture of a PACS 40. Components in system 40, identical to components of system 10 (shown in FIG. 1), are identified in FIG. 2 using the same reference numerals used in FIG. 1. System 40 includes a server system 42 and client systems 44. Server system 42 further includes a database server 46, an application server 20, and a web server 16. Servers 16, 20, and 46 are coupled in a local area network (LAN) 56. In addition, a system administrator's workstation 58, a user workstation 60, and a supervisor's workstation 62 are coupled to LAN 56. Alternatively, workstations 58, 60, and 62 are coupled to LAN 56 via an Internet link or are connected through an Intranet.

Each workstation, 58, 60, and 62 is a personal computer having a web browser. Although the functions performed at the workstations typically are illustrated as being performed at respective workstations 58, 60, and 62, such functions can be performed at one of many personal computers coupled to LAN 56. Workstations 58, 60, and 62 are illustrated as being associated with separate functions only to facilitate an understanding of the different types of functions that can be performed by individuals having access to LAN 56.

Server system 42 is configured to be communicatively coupled to various individuals, including employees 64 and to third parties, e.g., outside patent attorneys, 66 via an ISP Internet connection 68. The communication in the example embodiment is illustrated as being performed via the Internet, however, any other wide area network (WAN) type communication can be utilized in other embodiments, i.e., the systems and processes are not limited to being practiced via the Internet. In addition, and rather than WAN 70, LAN 56 could be used in place of WAN 70.

In the example embodiment, any authorized individual having a workstation 74 can access PACS 40. At least one of the client systems includes a manager workstation 76 located at a remote location. Workstations 74 and 76 are personal computers having a web browser. Also, workstations 74 and 76 are configured to communicate with server system 42.

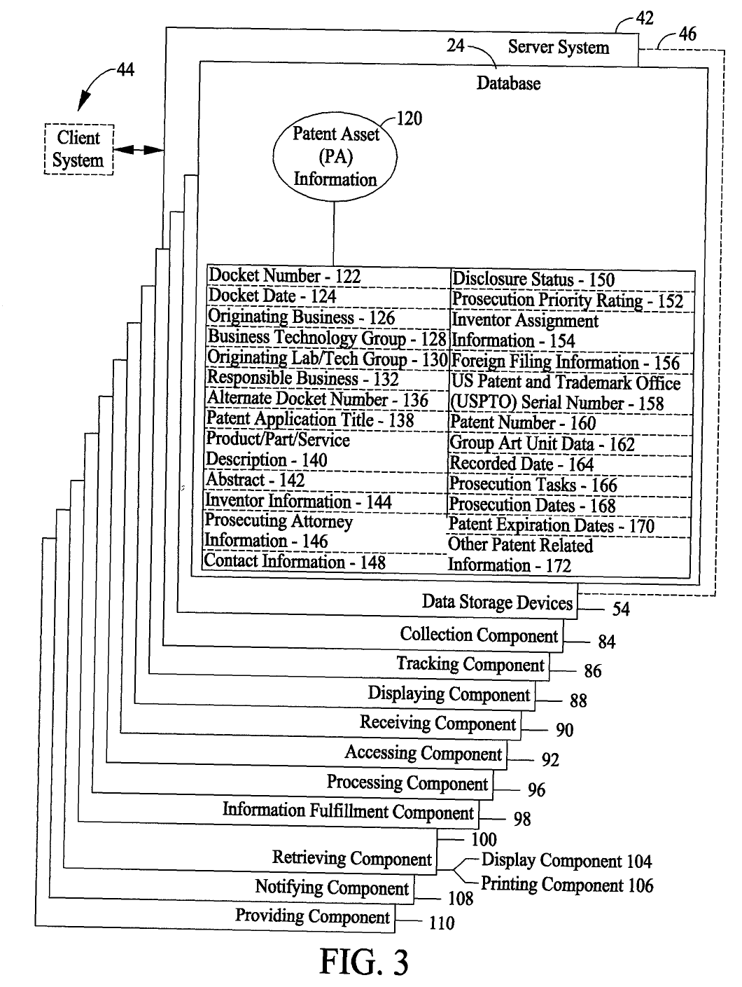

FIG. 3 illustrates an example configuration of database 24 within database server 46 of server system 42 shown in FIGS. 1 and 2. Database 24 is coupled to several separate computer software components within server system 42 which perform specific tasks. In the example embodiment, server system 42 includes a collection component 84 for collecting data from users in database 24, a tracking component 86 for tracking data, and a displaying component 88 to display information. Tracking component 86 tracks and cross-references data, including modifying existing data.

Server system 42 also includes a receiving component 90 to receive a specific query from client system 44, and an accessing component 92 to access database 24 within data storage device 54. Receiving component 90 is programmed to receive a query from one of a plurality of users. Server system 42 further includes a processing component 96 for searching and processing received queries against database 24 containing a variety of information collected by collection component 84. An information fulfillment component 98, located in server system 42, enables the requested information to be downloaded to the plurality of users in response to the requests received by receiving component 90. Information fulfillment component 98 downloads the information after the information is retrieved from database 24 by a retrieving component 100. Retrieving component 100 retrieves, downloads and sends information to client system 44 based on a query received from client system 44.

Retrieving component 100 also includes a display component 104 that is configured to download information to be displayed on a client system's graphical user interface and a printing component 106 that is configured to print information. Retrieving component 100 generates reports requested by the user through client system 44 in a pre-determined format. System 10 (shown in FIG. 1) is flexible to provide other alternative types of reports and is not constrained to the options set forth above.

Server system 42 also includes a notifying component 108 and a providing component 110. Notifying component 108 electronically transmits a message to client system 44 based on information inputted into server system 42, notifying a user of upcoming tasks and deadlines. Providing component 110 electronically provides a report to manager workstation 76 (shown in FIG. 2) summarizing PA information for a specific matter.

In one embodiment, collection component 84, tracking component 86, displaying component 88, receiving component 90, processing component 96, information fulfillment component 98, retrieving component 100, display component 104, printing component 106, notifying component 108, and providing component 110 are computer programs embodied on computer readable medium.

Database 24 stores Patent Asset (PA) information 120 for each patent related matter within a business entity. PA information 120 includes at least one of a docket number 122, a docket date 124, an originating business 126, a business technology group 128, an originating lab/technology group 130, a responsible business 132, an alternate docket number 136, a patent application title 138, a product/part/service description 140, an abstract 142, inventor information 144, prosecuting attorney information 146, contact information 148, a disclosure status 150, a prosecution priority rating 152, inventor assignment information 154, foreign filing information 156, a U.S. Patent and Trademark Office (USPTO) Serial Number 158, a Patent Number 160, Group Art Unit data 162, a recorded date 164, prosecution tasks 166, prosecution dates 168, patent expiration dates 170, and other patent related information 172.

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on business-entity. The administration/editing capabilities within system 10 are also restricted to ensure that only authorized individuals have access to modify or edit the data existing in the system. System 10 manages and controls access to system data and information.

The architectures of system 10 as well as various components of system 10 are example only. Other architectures are possible and can be utilized in connection with practicing the processes described below.

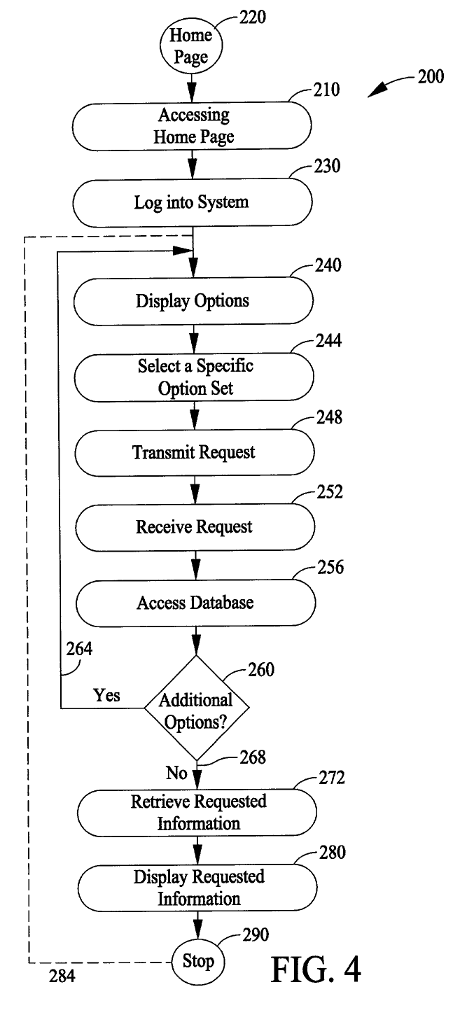

FIG. 4 is a flowchart 200 illustrating example processes utilized by system 10. Initially, a user accesses 210 a user interface, such as a home page 220, of the web site through client system 44 (shown in FIG. 2). In one embodiment, client system 44, as well as server system 42, are protected from access by unauthorized individuals. The user logs in 230 to system 10 using a password (not shown) for security.

Client system 44 displays 240 options available to the user through links, check boxes, or pull-down lists. Once the user selects 244 an option from the available links, the request is transmitted 248 to server system 42. The technical effect produced by the system is achieved by first logging onto the system, and then selecting an option provided by the system. Transmitting 248 the request is accomplished, in one embodiment, by click of a mouse. Once server system 42 (shown in FIG. 2) receives 252 the request, server system 42 accesses 256 database 24 (shown in FIG. 1). System 10 determines 260 if additional narrowing options are available. In one embodiment, additional narrowing options include patent related links, check boxes, or pull-down lists. If additional narrowing options are available 264, system 10 displays 240 the options relating to the prior option selected by the user on client system 44. The user selects 244 the desired option and transmits the request 248. Server system 42 receives the request 252 and accesses 256 database 24. When system 10 determines that additional options 260 are not available 268, system 10 retrieves 272 requested information from database 24. The requested information is provided 280 to client system 44 from server 42. The user may continue to search 284 database 24 for other information or exit 290 from system 10.

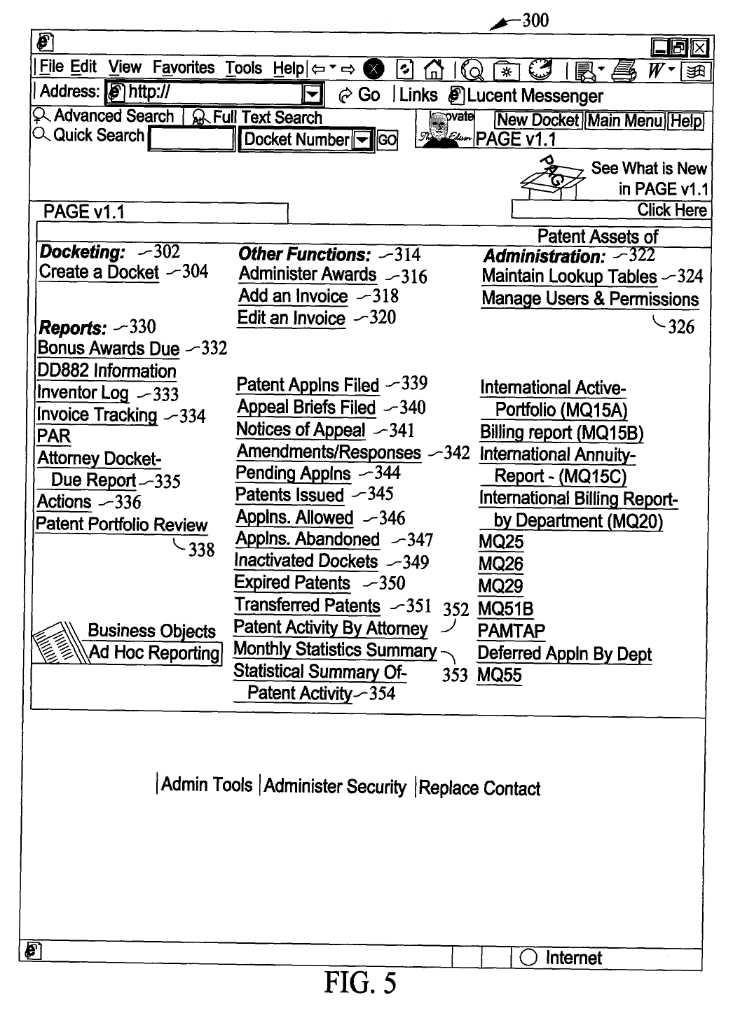

FIG. 5 is an example embodiment of a user interface 300 displaying a home page of PACS 10 (shown in FIG. 1) after a user has logged onto PACS 10. User interface 300 displays a plurality of links that enable a user to input or access information stored within PACS 10. The links displayed on user interface 300 under Docketing section 302 include at least a Create a Docket link 304. User interface 300 also displays links under Other Functions section 314 that include at least one of an Administer Awards link 316, an Add an Invoice link 318, and an Edit an Invoice link 320. User interface 300 also displays links under an Administration section 322 that include at least one of a Maintain Lookup Tables link 324 and a Manage Users & Permissions link 326.

User interface 300 displays links under a Reports section 330 that include at least one of a Bonus Awards Due link 332, a DD882 Information link which gives a report on contracts, an Inventor Log link 333, an Invoice Tracking link 334, a Patent Administrative Record (PAR) link, an Attorney Docket Due Report link 335, an Actions link 336, a Patent Portfolio Review link 338, a Business Objects link for Ad Hoc Reporting, a Patent Applications Filed link 339, an Appeals Briefs Filed link 340, a Notice of Appeal link 341, an Amendments/Responses link 342, a Pending Applications link 344, a Patents Issued link 345, an Applications Allowed link 346, an Applications Abandoned link 347, an Inactivated Dockets link 349, an Expired Patents link 350, a Transferred Patents link 351, a Patent Activity by Attorney link 352, a Monthly Statistics Summary link 353, and a Statistical Summary of Patent Activity link 354, an International Active Portfolio (MQ15A) link, a Billing report (MQ15B) link, an International Annuity Report (MQ15C) link, an International Billing Report by Department (MQ20) link, a Report by Country for all selected Departments (MQ25) link, a Report by Department for all or selected Departments (MQ26) link, a Foreign Maintenance Report for all or selected Countries per month or year (MQ29) link, a Report for all or selected Dropped Countries by drop date (MQ29) link, a Report on updated information for Annuity Payments (PAMTAP) link, a Deferred Application by Department link, and a Deferred Application by Attorney (MQ55) link.

User interface 300 also displays quick links in the upper right and left comers of the screen and at the bottom of the screen that include at least one of a New Docket link a Main Menu link, a Help link, an Advanced Search link, a Full Text Search link, a Quick Search field with a corresponding pull-down menu, a Ticket Tracker link, Administrative Tools link, Administer Security link, and Replace Contact link.

In the example embodiment, user interface 300 displays the links as text. Although text links are illustrated in the example embodiment, buttons, pull-down lists, check boxes, and other means for inputting information could also be used. User interface 300 is the entry point to access database 24 (shown in FIG. 1) via the web. After selecting the appropriate link, the user is provided with a screen shot that prompts the user to input information or provides the user with information.

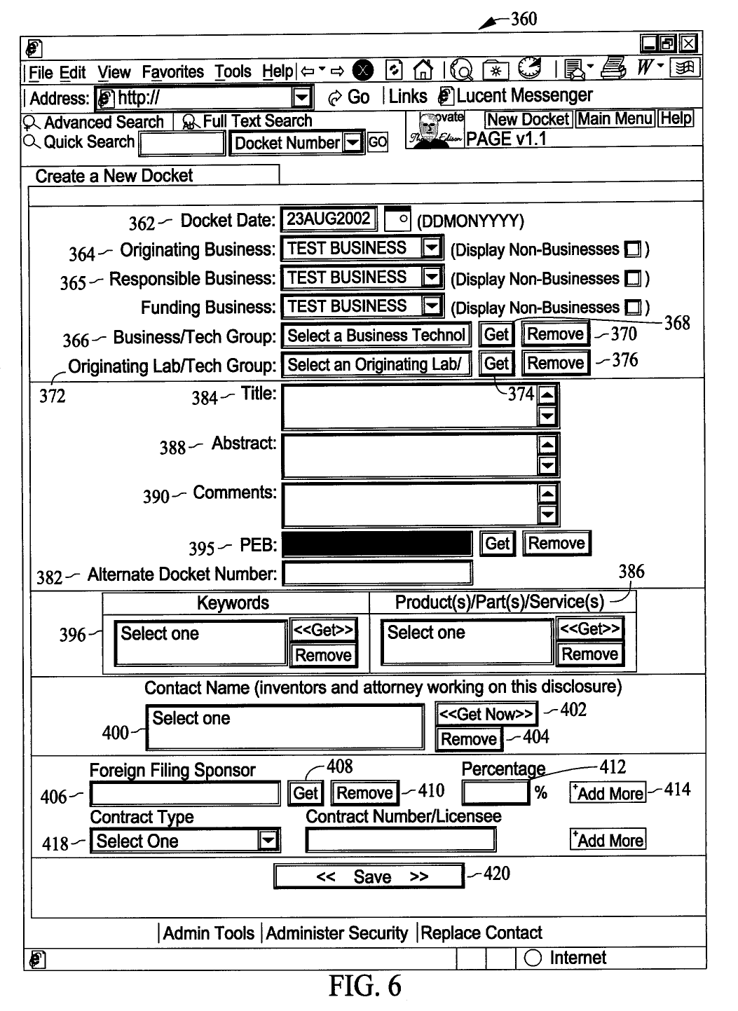

FIG. 6 is an example embodiment of a user interface 360 displaying a create a new docket page within PACS 10 (shown in FIG. 1). User interface 360 is displayed after a user clicks Create a Docket button link 304 or New Docket link shown on user interface 300 (shown in FIG. 5). User interface 360 displays a plurality of data fields, pull-down lists, buttons, and links that enable a user to create a docket by inputting PA information into PACS 10. The term “docket” as used herein is a disclosure that is the actual notification by an inventor or inventors of an invention that triggers the patenting process.

In the example embodiment, user interface 360 displays at least one of a Docket Date data field 362, an Originating Business pull-down list 364 and a complete business pull-down list, a Responsible Business pull-down list 365 and a complete business pull-down list, a Funding Business pull-down list and a complete business pull-down list, a Business/Technology Group data field 366 with a corresponding Get button 368 and Remove button 370, an Originating Lab/Technology Group data field 372 with a corresponding Get button 374 and Remove button 376, an Alternate Docket Number data field 382, a Title data field 384, a Product(s)/Part(s)/Service(s) data field 386 with corresponding Get button and Remove button, an Abstract data field 388, a Comments data field 390, a Patent Evaluation Board (PEB) data field 395 with a corresponding Get button and Remove button, a Priority pull-down list, and a Keyword data field 396 with corresponding Get button and Remove button.

The docket date entered into Docket Date data field 362 is the creation date of the docket. It establishes the internal anniversary date for the system. In the example embodiment, the data displayed in Business/Technology Group data field 366 displays the current ownership and responsibility for the specific docket. Get button 368 enables a user to display a pop up window that prompts the user to select a lab or technology group to be entered. Similarly, Originating Lab/Technology Group data field 372 displays the lab or technology group within the business entity that created the docketed matter. Get button 374 enables a user to display a pop up window that prompts the user to select a lab or technology group within the business entity that can be entered. Responsible Business pull-down list 365 enables a user to enter the business within the business entity that owns and is responsible for the docketed matter. PACS 10 is configured such that the owning business drives editing permissions within PACS 10 and drives all metrics and at least some of the “by Business” reports. Identifying an originating business, a responsible business, a funding business, lab/tech groups, and originating lab/tech groups allows the dockets to be associated at different levels and allows the user the ability and flexibility to arrange reports and retrieve records in multiple outputs. Keywords and Product(s)/Part(s)/Service(s) allow the user flexibility in reporting and retrieving as the keywords and products/parts/services can be associated at the different levels of docket, originating business, responsible business, funding business, lab/tech groups and originating lab/tech groups.

Title data field 384 includes the actual title of the disclosure. Abstract data field 388 includes the actual abstract of the disclosure.

User interface 360 also displays a Contact Name data box 400 with a corresponding Get Now button 402 and Remove button 404, a Foreign Filing Sponsor data field 406 with a corresponding Get button 408 and Remove button 410, a Percentage data field 412 with a corresponding Add More button 414, a Contract Type pull-down list 418 with corresponding text field for the Contract Number or Licensee and an Add More button, and a Save button 420.

Contact name data box 400 includes at least one of a list of inventors, an outside attorney responsible for the prosecution of the disclosure, and an in-house attorney responsible for managing the prosecution of the disclosure. Get Now button 402 enables a user to select from a pop up window the inventors or attorneys that are involved with the disclosure. Foreign Filing Sponsor data field 406 displays the department that is responsible for foreign filing expenses, and Percentage data field 412 displays the percentage of the fees that the sponsor is responsible for.

In the example embodiment, at least some of the data fields displayed on user interface 360 are searchable and are used for reporting purposes. Some fields are required when creating a docket. The required fields are displayed in bold on the screen and include at least one of: Docket Date, Originating Business, Responsible Business, Business Technology Group and Inventor, and in-house counsel in the Contact field.

Dates may be entered directly by the user by typing into the date fields or by accessing a calendar button, which allows the user to select the month, day and year. The date selected is then automatically filled into the date field. All dates must be entered in a ddmmmyyyy format.

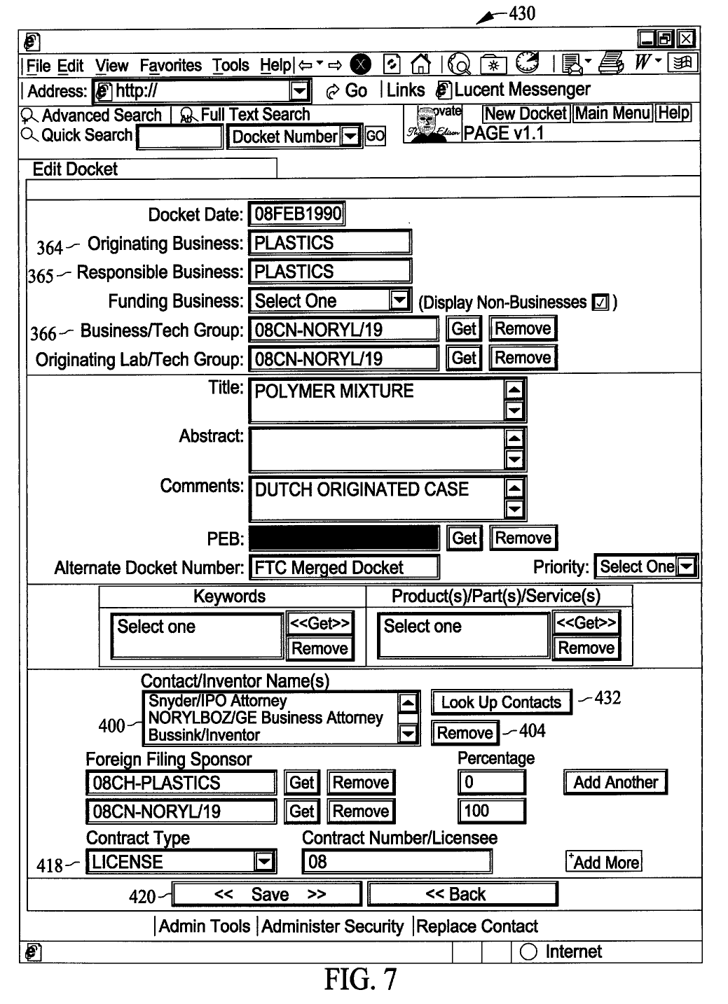

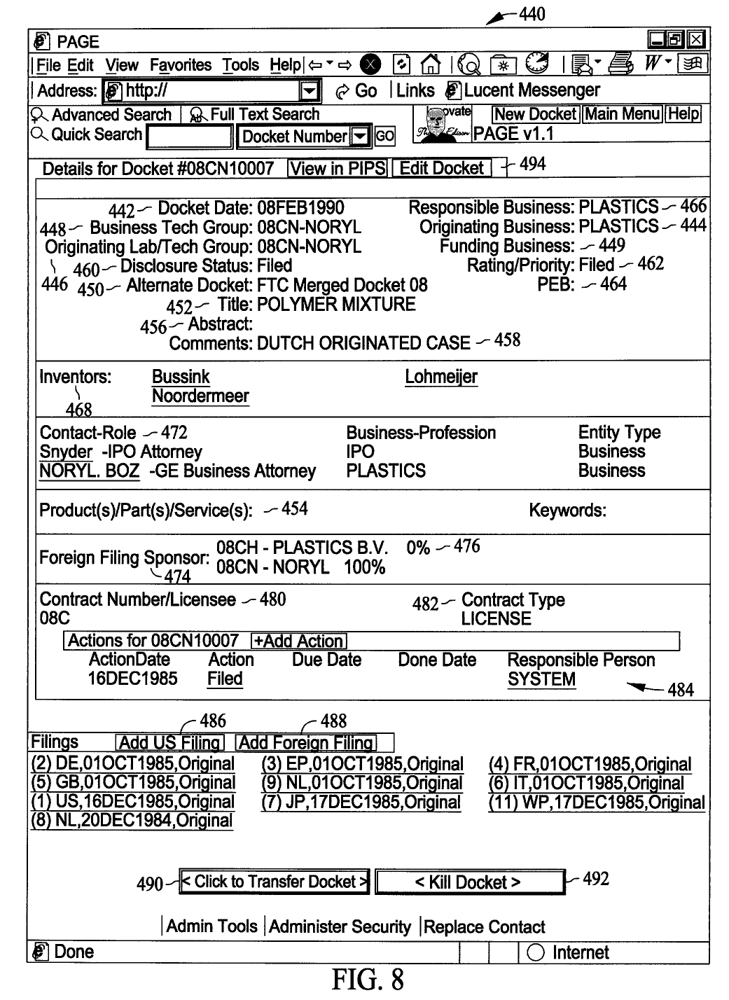

FIG. 7 is an example embodiment of a user interface 430 displaying an edit docket details page within PACS 10 (shown in FIG. 1). A user may edit certain PA information displayed on user interface 360 (shown in FIG. 6) by selecting an Edit Docket link as described below in FIG. 8. The user utilizes the Edit Docket function when the details of a docket change during the course of the docket lifecycle. This enables the user to maintain the PA information relating to a specific docket matter. For example, events that may require a user to change certain information relating to a docketed matter may include: (i) an addition or deletion of inventors, or (ii) assigning a disclosure to outside counsel for application drafting.

In the example embodiment, the data fields that are available when utilizing the Edit Docket function are the same as the data fields for Creating a Docket with the exception of Originating Business pull-down list 364 which is a read only data field within the Edit Docket function, and Responsible Business pull-down list 365 which is also a read only data field within the Edit Docket function. In the example embodiment, Responsible Business pull-down list 365 can only be changed after creating the docket by transferring the docket.

In the example embodiment, changing the docket status as shown in Disclosure Status pull-down list 392 may be performed through the Edit Docket function. The docket status should be changed when a docket becomes Inactivated, Filed, Consolidated, or when the Disclosure is Published. In the example embodiment, changing the status of a docket is beneficial for the user interface, but does not affect reporting or metrics.

In the example embodiment, adding or removing an inventor as shown in Contact Name data box 400 may be performed through the Edit Docket function. To add an additional inventor, a user may invoke a search pop up window by clicking on Look Up Contacts button 432, entering the last name of the inventor, and selecting the appropriate contact from the list. The user then selects “Inventor” from a drop down list, clicks a right arrow button (not shown), clicks an “Add and Close” button (not shown), and the inventor is added to the docket. The user then selects “Submit” (not shown) to save the changes. To remove an inventor from the docket, the user selects the individual from the Contact list and clicks on Remove button 404.

In the example embodiment, a contact may also be added to the Contact list by clicking an Add One Here link (not shown). A pop-up window will be displayed (not shown) to allow the user to enter a contact. The pop-up window displays at least one of: social security number data field, an employee id number data field, data fields for first and last name, address data fields, a profession data field, a citizenship data field, a designation data field, a Business pull-down list and a contact type section. The contact type section includes at least one of: inventor, assignee, outside counsel, Sr. patent counsel, business attorney, attorney, chief docket clerk, patent engineer, maintenance fees, agent, patent administrator, business and system and corresponding check boxes for each contact type. The user enters the desired information into the data fields and clicks on the check boxes for each appropriate contact type. A contact may have multiple contact types. Only the first name, last name and Business are required fields to enter to create a contact.

In the example embodiment, adding execution data may be performed through the Edit Docket function. When an inventor has signed execution papers, a docket administrator should record the event in PACS 10. To do so, the docket administrator opens the specific docket or disclosure for which the inventor has signed the execution papers, and selects “Inventor Execution Date” (not shown in FIG. 7) from Contact Name data box 400. This will cause PACS 10 to display all of the inventors for that specific docket, and provides a data field in which the docket administrator can enter an execution date. The docket administrator then clicks Save button 420 to record the execution information. In the example embodiment, this process of adding execution data may also be accomplished through a Bonus Module or a Batch Bonus Interface.

In the example embodiment, adding or removing an attorney, agent, or administrator as shown in Contact Name data box 400 may be performed through the Edit Docket function. To add an additional attorney, a user may invoke a search pop up window by clicking on Look Up Contacts button 432, entering the last name of the attorney, and selecting the appropriate contact from the list. The user then selects “Attorney” from a role drop down list (not shown), clicks a right arrow button (not shown), clicks an “Add and Close” button (not shown), and the attorney is added to the docket. The user then selects Submit (not shown) to save the changes. To remove an attorney, agent, or administrator from the docket, the user selects the individual from the Contact list and clicks on Remove button 404.

In the example embodiment, contracts can be modified and removed from the system through the Edit Docket function. Additional contracts can also be added to the docket at any time. To modify a contract, a user will click on the down arrow on Contract Type pull-down list 418, and then selects a different Type of contract from the pull-down list. A user may also edit a Contract Number shown in a data field next to Contract Type pull-down list 418. To remove a contract, a user will select a blank contract type from Contract Type pull-down list 418. To add an additional contract type, a user will select an “Add More” link. After the screen refreshes, a new data field will be displayed below the current contract. To save the changes, the user will select Save button 420.

FIG. 8 is an example embodiment of a user interface 440 displaying a docket details page for a specific docket within PACS 10 (shown in FIG. 1) after the PA information for the docket has been entered. User interface 440 displays a plurality of data fields showing the entered PA information for the specific docket.

In the example embodiment, user interface 440 displays at least one of a Docket Date data field 442, an Originating Business data field 444, a Business Technology Group data field, an Originating Lab/Technology Group data field 446, a Business Technology Group data field 448, a Funding Business data field 449, an Alternate Docket Number data field 450, a Title data field 452, a Product(s)/Part(s)/Service(s) data field 454, an Abstract data field 456, a Comments data field 458, a Disclosure Status data field 460, a Rating/Priority data field 462, a Patent Evaluation Board (PEB) data field 464, a Responsible Business data field 466, an Inventors data field 468, a Contact-Role data field 472, a Foreign Filing Sponsor data field 474, a Percent data field 476, a Contract Number data field 480, a Contract Type data field 482, an Action table 484, an Add U.S. Filing link 486, an Add Foreign Filing link 488, a Click to Transfer Docket link 490, and a Kill Docket link 492.

In the example embodiment, user interface 440 enables a docket administrator to transfer a docket from one business to another business by clicking on Transfer Docket link 490. When a docket administrator clicks on Transfer Docket link 490, a new screen is displayed that includes at least one of a Transfer Date data field with the date populated as a read-only field, a Responsible Business From data field, a Responsible Business To pull-down list, and an Associated Filings table. To initiate a transfer, the docket administrator selects the receiving business from the Responsible Business To pull-down list and selects the Filings for the transfer from the Associated Filings table. The docket administrator then clicks on a Save button to complete the transfer. The transfer will then be recorded within PACS 10 as a disclosure action on the docket and the Responsible Business field will be associated with the receiving business. In the example embodiment, once the docket is transferred, the docket administrator no longer has access to the docket. If the transfer is in error, the original docket administrator will have to contact the receiving business and request that the docket be transferred back to the original business.

In the example embodiment, user interface 440 also displays an Edit Docket link 494. As discussed above, a user may edit certain PA information displayed on user interface 360 (shown in FIG. 6) by selecting Edit Docket link 494. The user utilizes the Edit Docket function when the details of a docket change during the course of the docket lifecycle. This enables the user to maintain the PA information relating to a specific docket matter.

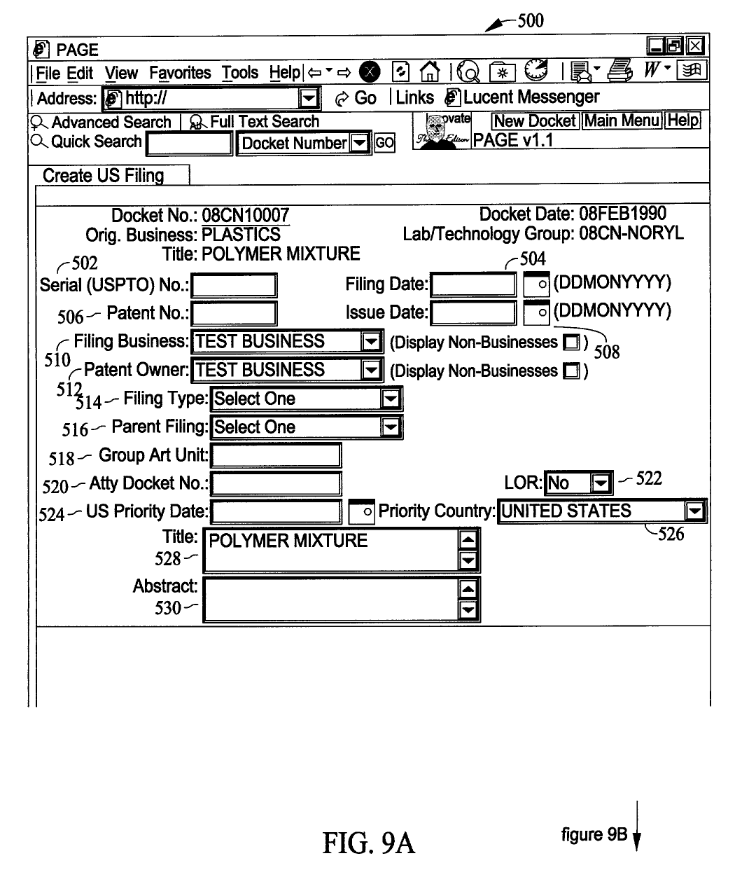

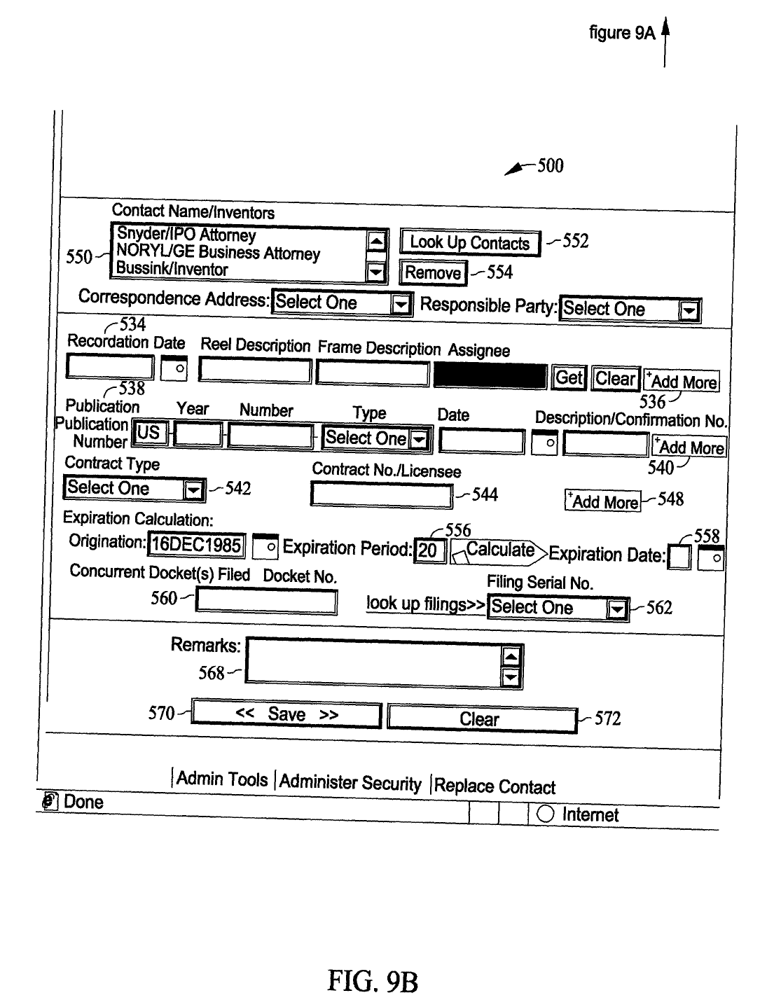

FIG. 9 is an example embodiment of a user interface 500 displaying an add U.S. filing page within PACS 10 (shown in FIG. 1). User interface 500 is displayed after a user clicks on Add U.S. Filing link 486 on user interface 440 (shown in FIG. 8). A filing is a patent application. Common filing types include at least one of Provisional, Original, Divisional, and Continuation in Part (CIP). One docket can have multiple filings associated with it. Since, in the example embodiment, a docket is roughly analogous to a disclosure, and since one disclosure can give rise to multiple domestic and foreign patents, multiple filings can be associated with one docket.

In the example embodiment, upon approval of a filing, a docket administrator creates a new filing in PACS 10. To create a filing, a docket administrator will enter at least the following information into user interface 500: a business currently responsible for the technology, a type of filing (e.g., original, provisional, divisional, continuation, and CIP), a patent owner, and a filing date, as well as at least one of a patent number, and a serial number to which the filing is related.

In the example embodiment, user interface 500 displays at least one of a USPTO Serial Number data field 502, a Filing Date data field 504 with a corresponding calendar for entering a date, a Patent Number data field 506, an Issue Date data field 508 with a corresponding calendar for entering a date, a Filing Business pull-down list 510 with a corresponding complete pull-down list, a Patent Owner pull-down list 512 with a corresponding complete pull-down list, a Filing Type pull-down list 514, a Parent Filing pull-down list 516, a Group Art Unit data field 518, an Attorney Docket Number data field 520, a License of Right (LOR) pull-down list 522, a Priority Date data field 524, a Priority Country pull-down list 526, a Title data field 528, and an Abstract data field 530.

In the example embodiment, Filing Type pull-down list 514 includes at least one of Original, Provisional, Continuation, Re-Issue, Re-Examination, Divisional, Continuation in Part, Design, and Interference. When the U.S. filing record is saved, a foreign filing decision date (i.e., FF Callup Date) action is entered in the Action Table if it is the first U.S. filing for that docket.

Parent Filing pull-down list 516 enables PACS 10 to maintain legacy data for the docketed matter. In the example embodiment, new child filings can be filed as children of the existing dockets. The Parent Filing field allows the user to indicate the direct parent of the new filing.

User interface 500 also displays a Recordation data section 534 that includes an Add More button 536, a Publication data section 538 that includes an Add More button 540, a Contract Type pull-down list 542, a Contract Number/Licensee data field 544, an Add More button 548, a Contact Name/Inventors data box 550 with a corresponding Look Up Contacts button 552 and Remove button 554, a Correspondence Address pull-down list, a Responsible Party pull-down list, an Expiration Calculation section that includes an Origination data field with calendar, an Expiration Period data field 556, a Calculate button and an Expiration Date data field 558 with calendar, a Concurrent Dockets Filed Docket Number data field 560, a Filing Serial Number pull-down list 562, a Remarks data box 568, a Save button 570, and a Clear button 572.

Contact Name/Inventor data box 550 includes at least one of a list of inventors, an outside attorney responsible for the prosecution of the disclosure, and an in-house attorney responsible for managing the prosecution of the disclosure. Look Up Contacts button 552 enables a user to select from a pop up window the inventors or attorneys that are involved with the docket. In the example embodiment, at least some of the data fields displayed on user interface 500 are searchable and are used for reporting purposes. Some fields are required when creating a U.S. filing. The required fields are in bold on the screen and include at least one of: Filing Business, Patent Owner, and Filing Type.

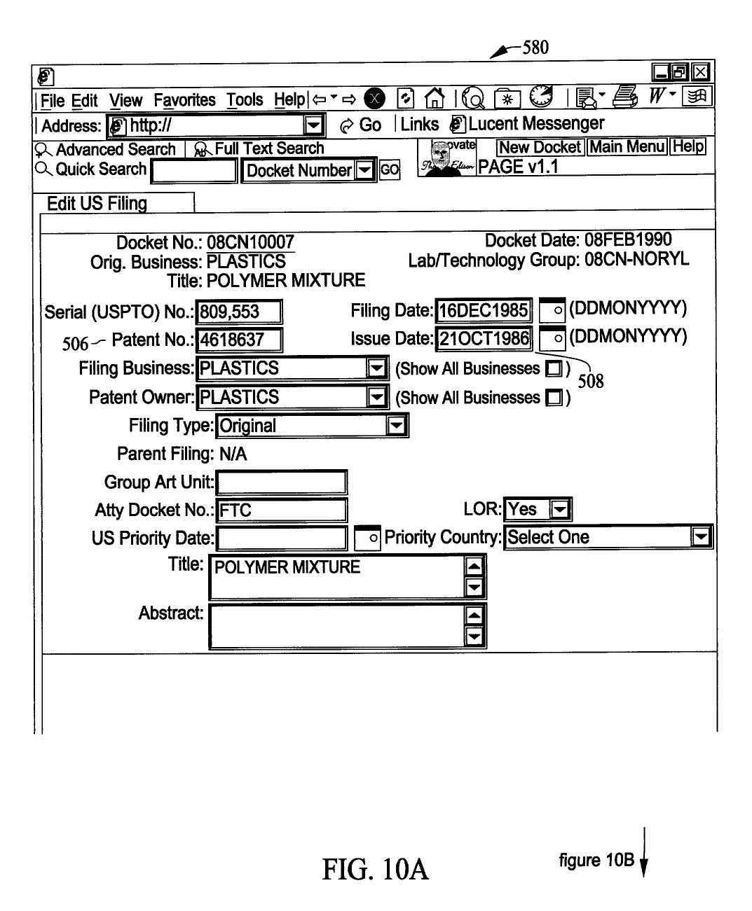

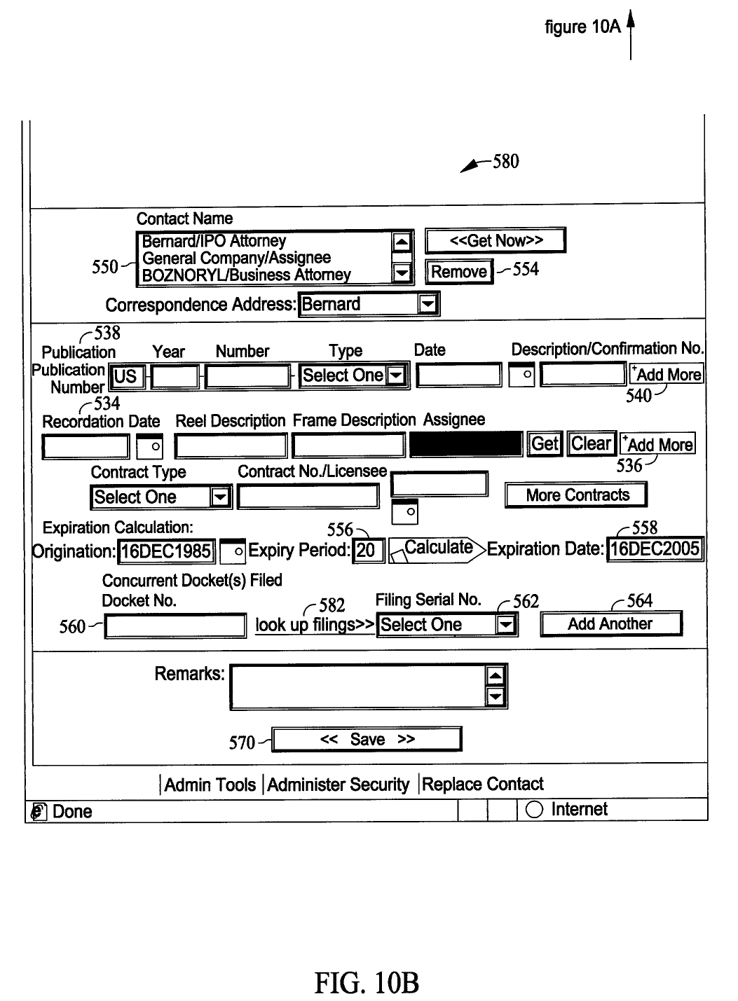

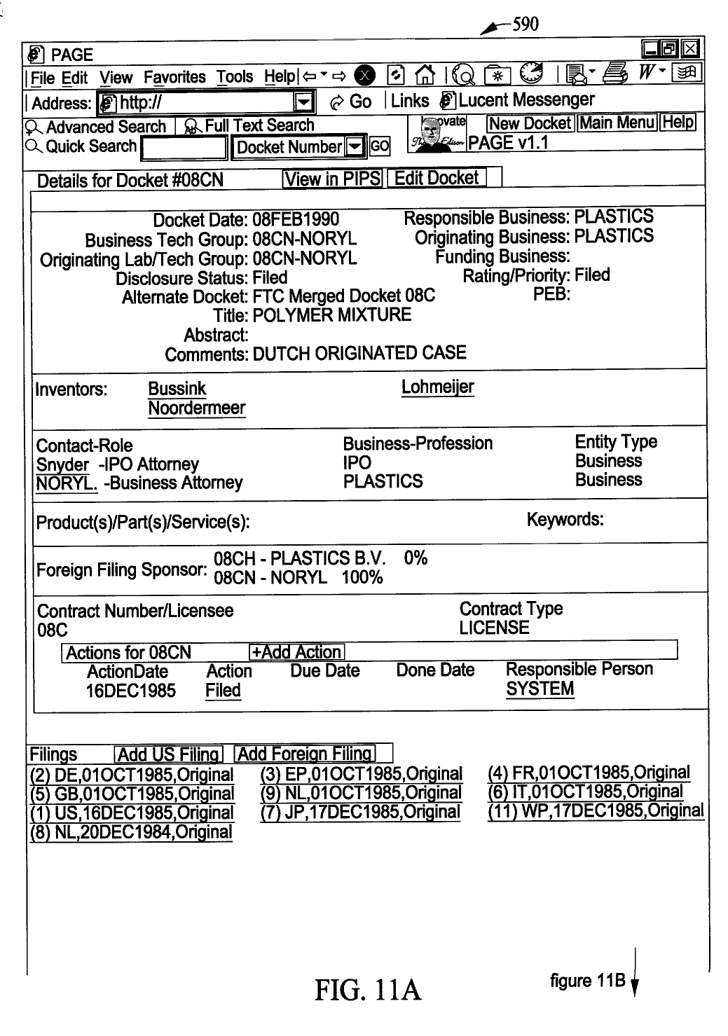

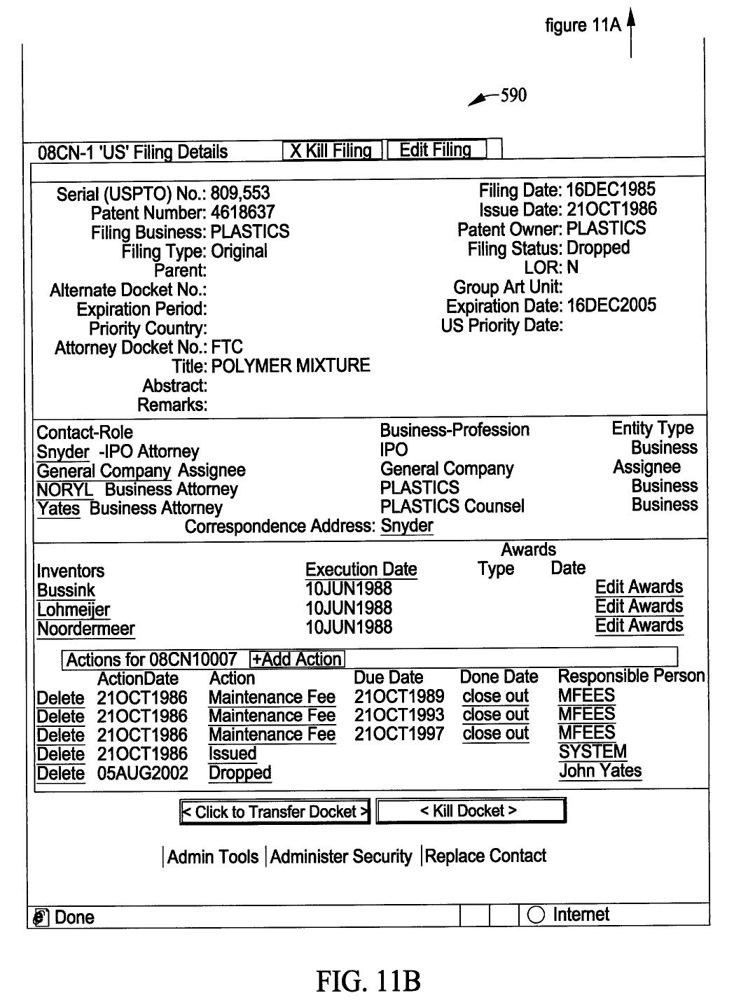

FIG. 10 is an example embodiment of a user interface 580 displaying an edit U.S. filing page within PACS 10 (shown in FIG. 1). A user may edit certain PA information displayed on user interface 500 (shown in FIG. 9) by selecting an Edit Filing link as described below in FIG. 11. The user utilizes the Edit a Filing function when the filing details of a docket change during the course of the filing lifecycle or when the Patent is granted. The Edit a Filing function enables the user to maintain the PA information relating to a specific docket matter. For example, events that may require a user to change certain filing information relating to a docketed matter may include: (i) issuance of a Patent, (ii) an addition or deletion of inventors, or (iii) a change in attorney responsibility.

In the example embodiment, the data fields that are available when utilizing the Edit a Filing function are the same as the data fields for Add a U.S. Filing.

In the example embodiment, adding or removing an inventor as shown in Contact Name/Inventor data box 550 may be performed through the Edit a Filing function. To add an additional inventor, a user may invoke a search pop up window by clicking on Look Up Contacts button 552 (shown in FIG. 9), entering the last name of the inventor, and selecting the appropriate contact from the list. A Contact Details button (not shown) may be selected to provide more information about a contact. The user then selects “Inventor” from a role drop down list (not shown), clicks an Add button (not shown), clicks an “Add and Close” button (not shown), and the inventor is added to the docket. The user may indicate that the Inventor is to be named first on the patent application, by selecting First Named Inventor from the role drop-down list (not shown). The user then selects Submit (not shown) to save the changes. To remove an inventor from the docket, the user selects the individual from the Contact list and clicks on Remove button 554.

In the example embodiment, the issuance of a patent can be recorded through the Edit a Filing function. When the Patent Office issues a patent for an application, the Date of Issuance and the Patent Number must be entered into PACS 10. To do so, a user will open the specific filing in PACS 10 and select the Edit a Filing function. The user will then enter the Patent Number in Patent Number data field 506 and the Patent Date in Issue Date data field 508. Additionally, when issued, the Expiration Period should be entered in Expiration Period data field 556 and the date from when the patent term starts should be entered into an Origination data field. The Expiration Period defaults to 20 years and the Origination data field defaults to the Filing Date. When the Calculate button is clicked, the expiration date of the patent will be calculated and entered into Expiration Date data field 558. In another embodiment, the docket administrator can enter the patent expiration date directly into Expiration Date data field 558.

In the example embodiment, adding or removing an attorney, agent, or administrator as shown in Contact Name/inventor data box 550 may be performed through the Edit a Filing function. Filings that may occur after filings (e.g., Divisional or Continuation Filings) will be assigned the contacts from the parent docket. To add an additional attorney, a user may invoke a search pop up window by clicking on Look Up Contacts button 552 (shown in FIG. 9), entering the last name of the attorney, and selecting the appropriate contact from the list. The user then selects Company Business Attorney, IPO Attorney, or GRC Attorney from a role drop down list if the attorney is an in-house attorney responsible for the case or Outside Counsel from the role drop down list if the attorney prosecuting the case is outside counsel. The user then clicks an Add button (not shown), clicks an “Add and Close” button (not shown), and the attorney is added to the docket. The user then selects Submit (not shown) to save the changes. To remove an attorney, agent, or administrator from the docket, the user selects the individual from the Contact list and clicks on Remove button 554.

In the example embodiment, adding, removing, or editing recordation data may be performed through the Edit a Filing function. If a user has a current recordation in PACS 10, it will be displayed on user interface 500. The Recordation Date, Reel Description, Frame Description, and Assignee, which are displayed in Recordation data section 534, all may be edited through the Edit a Filing function. To add a second recordation, a user will click Add More button 536. If there are no current recordations, a blank entry is displayed for a user to enter a new recordation.

In the example embodiment, tracking concurrent filings may be performed through the Add U.S. Filing screen (shown in FIG. 9) or the Edit U.S. Filing screen (shown in FIG. 10). The concurrent filings function within PACS 10 enables a user to track applications that are submitted together to avoid either filing being cited against the other as prior art. While concurrent filings are not typical, it is important that a user can track “sibling” applications. To record a concurrent filing, a user will need at least one of (i) the Docket Number and Filing Number for the first filing, and (ii) the Docket Number and Filing Number for each filing in the concurrent application. To add a concurrency filing, a user must first open the specific filing in question by selecting the docket and appropriate file. Once the file is opened, the user clicks an Edit button to edit the filing. User interface 580 displays Concurrent Dockets Filed Docket Number data field 560, a Filing Serial Number pull-down list 562, and an Add Another button 564. A user enters the Docket Number of the sibling filing in Concurrent Dockets Filed Docket Number data field 560. Once entered, the user selects a Look Up Filings hyperlink 582. Filing Serial Number pull-down list 562 will then contain a list of filings for the sibling docket. The user then selects the appropriate filing number from Filing Serial Number pull-down list 562. If there are multiple concurrencies, the user clicks Add Another button 564 to create a new drop down for subsequent entries. The form is submitted by clicking Save button 570.

In the example embodiment, adding, removing, or editing publication data may be performed through the Edit a Filing function. If a user has a current publication in PACS 10, it will be displayed on user interface 500 (shown in FIG. 9). The Publication Number, which has four sections: (i) a field defaulted to U.S., (ii) a Year data field, (iii) a Number data field, and (iv) a Type pull-down list, the Date, and the Description/Confirmation Number are displayed on user interface 500 in Publication data section 538. All of these fields may be edited through the Edit a Filing function. To add a second publication, a user will click Add More button 540. If there are no current publications, a blank entry is displayed for a user to enter a new publication.

FIG. 11 is an example embodiment of a user interface 590 displaying a filings details page for a specific docket within PACS 10 (shown in FIG. 1). User interface 590 displays a plurality of data fields showing the entered filing details for the specific docket. In addition, and Execution Date link and an Awards section are displayed.

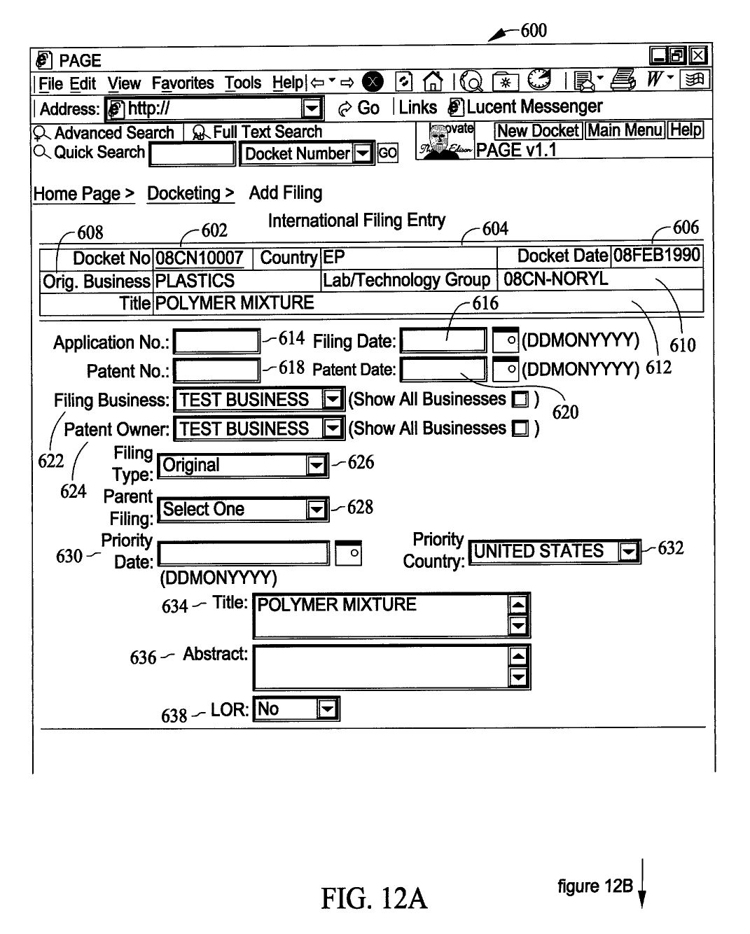

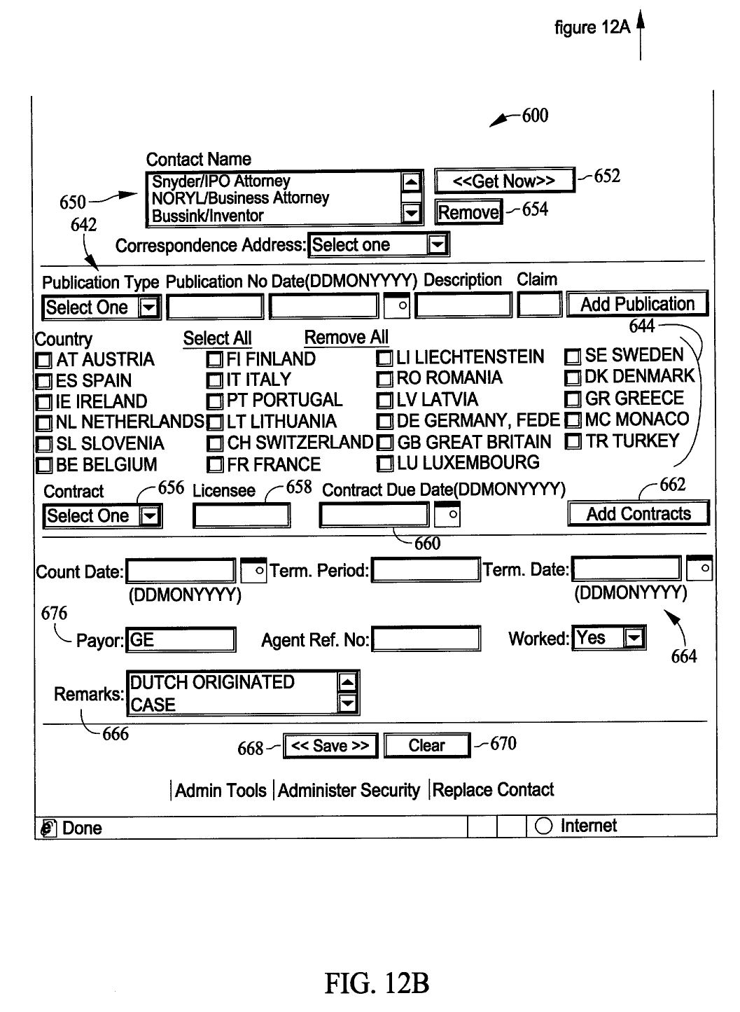

FIG. 12 is an example embodiment of a user interface 600 displaying an International Filing Entry page within PACS 10 (shown in FIG. 1). User interface 600 is displayed after a user clicks on Add Foreign Filing link 488 on user interface 440 (shown in FIG. 8). PACS 10 tracks both foreign filings and domestic (United States) filings. The primary differences between tracking foreign filings versus U.S filings include at least one of: (i) foreign filings have more Filing Types and Status options than U.S. filings, and (ii) PACS 10 has a separate module for European filings.

In the example embodiment, user interface 600 is displayed after a user clicks on Add Foreign Filing link 488 on user interface 440 (shown in FIG. 8) and selects the country for the filing from a pull-down list (not shown). User interface 600 displays at least one of a Docket Number data field 602, a Country data field 604, a Docket Date data field 606, an Originating Business data field 608, a Lab/Technology Group data field 610, a Title data field 612, an Application Number data field 614, a Filing Date data field 616, a Patent Number data field 618, a Patent Date data field 620, a Filing Business pull-down list 622, a Patent Owner pull-down list 624, a Filing Type pull-down list 626, a Parent Filing data filed 628, a Priority Date data field 630, a Priority Country pull-down list 632, a Title data box 634, an Abstract data box 636, and a License of Right (LOR) pull-down list 638.

User interface 600 also displays a Publication data section 642 that includes at least one of a Publication Type pull-down list, a Publication Number data field, a Publication Date data field with a corresponding calendar, a Publication Description data field, a Claim data field, and an Add Publication button. User interface 600 also displays a Contact Name data box 650 with a corresponding “Get Now” button 652 and Remove button 654. User interface also displays a Contract pull-down list 656, a Licensee data field 658, a Contract Due Date data field 660 with a corresponding calendar, an Add Contracts button 662, a Count Date data field with a corresponding calendar, a Termination Period data section 664, an Agent Reference Number data field, a Worked pull-down list, a Remarks data box 666, a Save button 668, a Clear button 670, and a Payor data field 676. If the user selected a European Patent Convention filing, user interface 600 also displays a plurality of countries with corresponding check boxes 644.

In the example embodiment, a user selects the Country from a pull-down list (not shown) where the application is to be foreign filed. The selected country is displayed on user interface 600 in Country data field 604. The Country list includes at least one of WIPO Filings and European Patent Convention. The country selection defaults to European Patent Convention. PACS 10 then displays a foreign filing record with certain data fields populated including at least one of Docket Number data field 602, Country data field 604, Docket Date data field 606, Original Business data field 608, Lab/Technology Group data field 610, Abstract data box 636, Contact Name data box 650, Correspondence Address pull-down list, and Remarks data box 666. Required data fields are displayed with bold headers and include at least one of Filing Business pull-down list 622, Patent Owner pull-down list 624, Filing Type pull-down list 626, LOR pull-down list 638, which defaults to “No”, and Contact Name data box 650. If the user has selected a European Patent Convention filing, the Country section to select the European countries is also in bold.

The user then selects the Filing Business from the pull-down list. The Filing Business is the business that is filing the foreign application. In the example embodiment, the Filing Business defaults to IPO. The user then selects the Patent Owner from the pull-down list. This is the business that is prosecuting the foreign application and maintaining the patent. In the example embodiment, the Filing Business defaults to IPO. The user then selects the Filing Type from the pull-down list. The Filing Type is the type of application filed, such as Original or Divisional. In the example embodiment, the Filing Type defaults to Original. The user then enters the Priority Date for the application and selects the Priority Country for the application. In the example embodiment, the Priority Country defaults to United States.

PACS 10 will populate Title data field 634 and the Abstract data field 636 with a title and abstract from the docket details. If needed, the Title and Abstract can be changed. Contact Name data box 650 is populated from the Docket Details and should include the IPO attorney prosecuting the application and may include an Outside Counsel. A Payor data field 676 defaults to the business entity that owns and pays for the application or patent. The user may also add remarks or comments in Remarks data box 666. The user then selects Save button 668 to save the entered information. Some fields are required when creating an international filing. The required fields are in bold on the screen and include at least one of: Filing Business, Patent Owner, and Filing Type.

User interface 600 displays a Filing Type for foreign filings in Filing Type pull-down list 626. In the example embodiment, Filing Type pull-down list 626 includes at least one of Original, Divisional, EPC-Filed, EPC-Filed Divisional, Design Application/Patent, and Reissue.

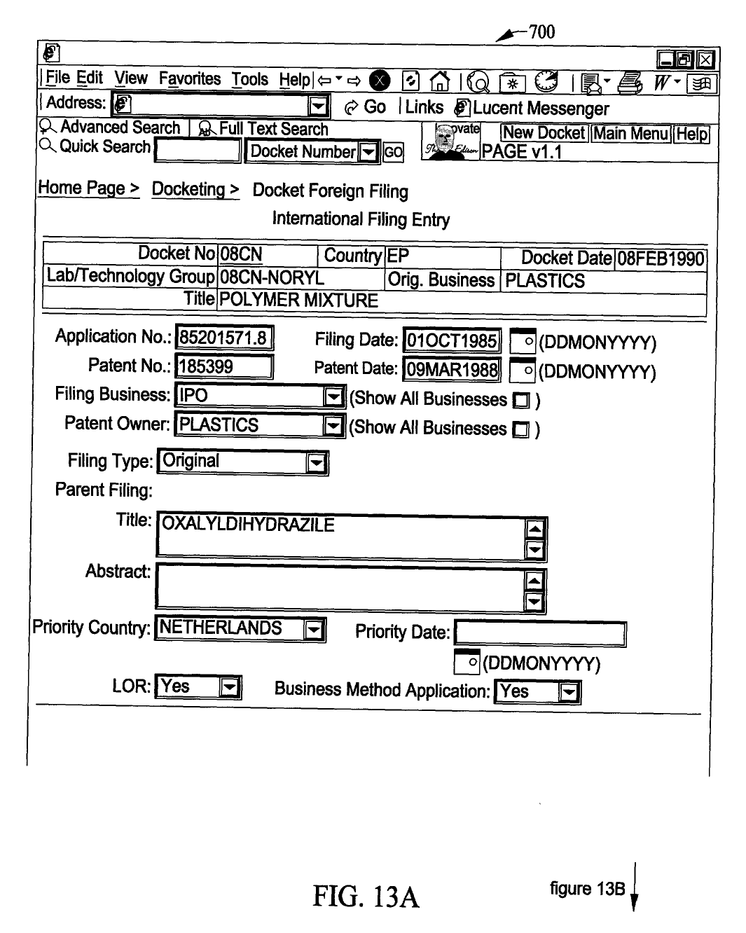

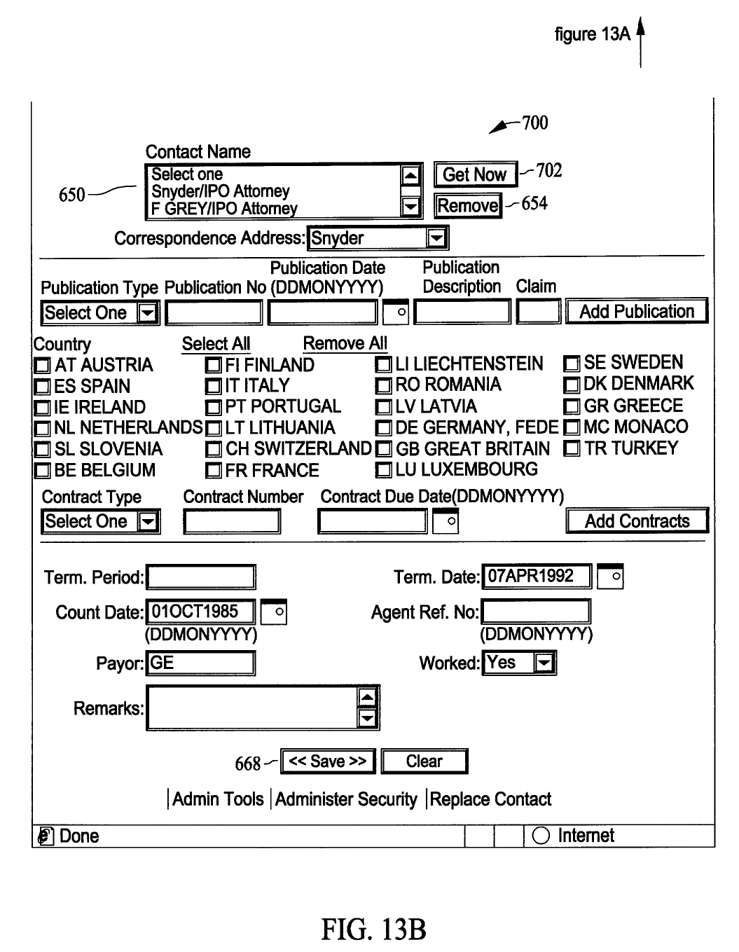

FIG. 13 is an example embodiment of a user interface 700 displaying an edit International Filing Entry page within PACS 10 (shown in FIG. 1). A user may edit certain PA information displayed on user interface 600 (shown in FIG. 12). The user edits a foreign filing when the filing details of a docket change during the course of the filing lifecycle or when the Patent is granted. Editing a foreign filing enables the user to maintain PA information relating to a specific docketed matter.

In the example embodiment, adding or removing an inventor as shown in Contact Name/Inventor data box 650 may be performed by editing a foreign filing. To add an additional inventor, a user may invoke a search pop up window by clicking on Get Now button 702, entering the last name of the inventor, and selecting the appropriate contact from the list. The user then selects “Inventor” from a drop down list (not shown), clicks an Add button (not shown), clicks an “Add and Close” button (not shown), and the inventor is added to the docket. The user then selects Submit button (not shown) to save the changes. To remove an inventor from the docket, the user selects the individual from the Contact list and clicks on Remove button 654.

In the example embodiment, adding or removing an attorney, docket clerk or assignee as shown in Contact Name/Inventor data box 650 may be performed by editing a foreign filing. Subsequent filings that may occur after earlier filings will be assigned the contacts from the parent docket. To add an additional attorney, a user may invoke a search pop up window by clicking on “Get Now” button 702, entering the last name of the attorney, and selecting the appropriate contact from the list. The user then selects “IPO Attorney” from a role drop down list if the attorney is an in-house IPO attorney responsible for the case or “Outside Counsel” from the role drop down list if the attorney is the outside counsel prosecuting the case. The user then clicks an Add button (not shown), clicks an “Add and Close” button (not shown), and the attorney is added to the docket. The user then selects a Submit button (not shown) to save the changes. To remove an attorney, docket clerk, or assignee from the docket, the user selects the individual from the Contact list and clicks on “Remove” button 654.

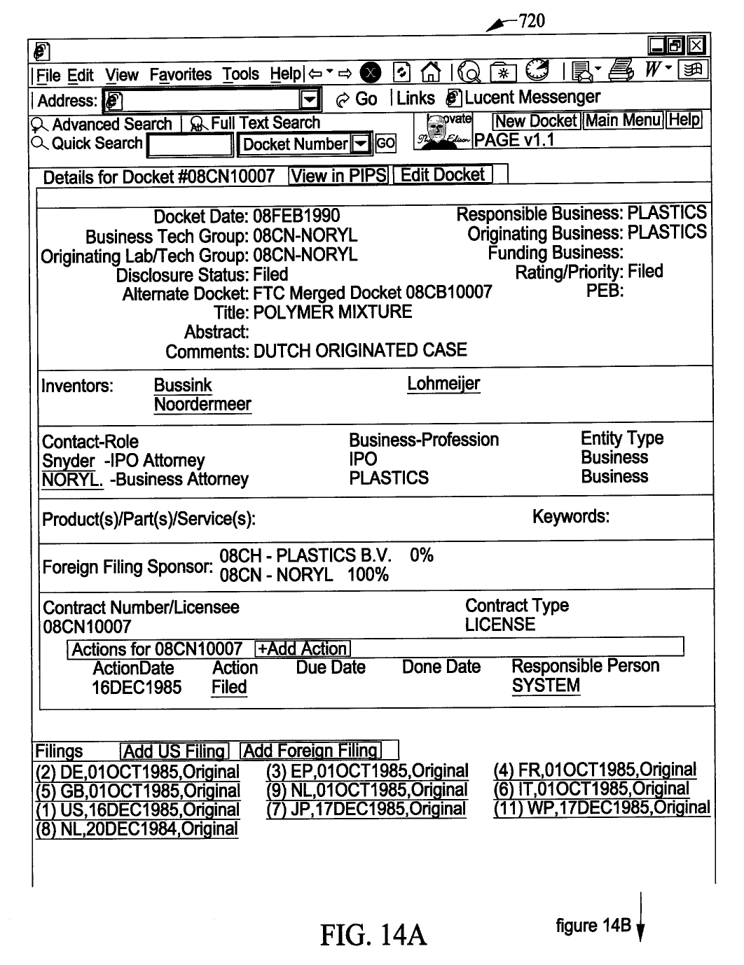

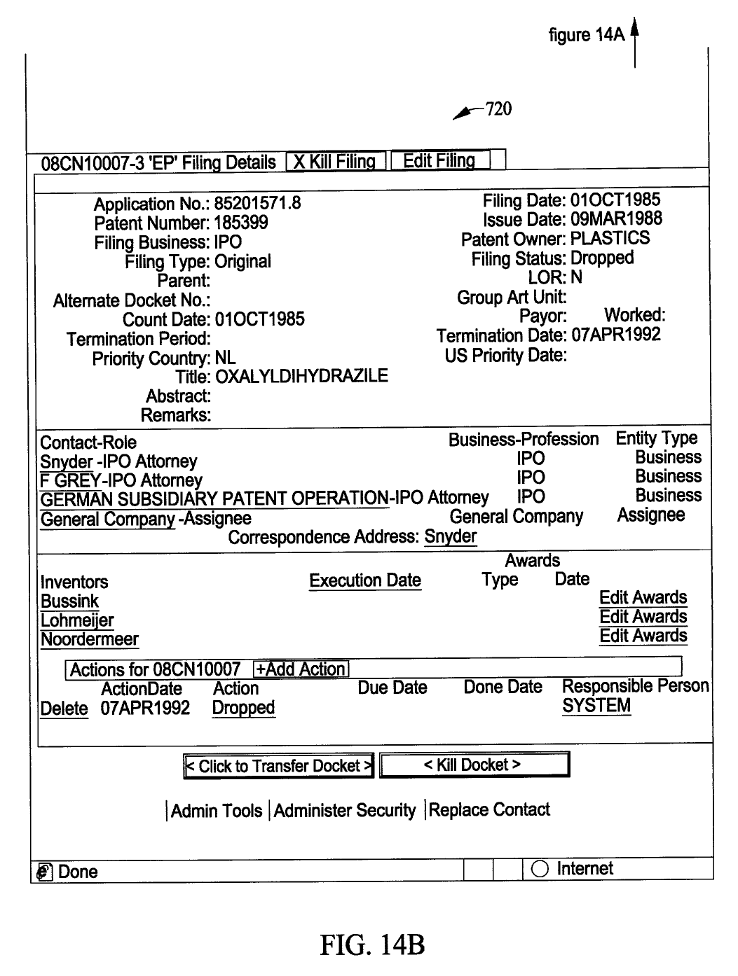

FIG. 14 is an example embodiment of a user interface 720 displaying an international (also known as foreign) filings details page for a specific docket within PACS 10 (shown in FIG. 1). User interface 720 displays a plurality of data fields showing the entered foreign filing details for the specific docket.

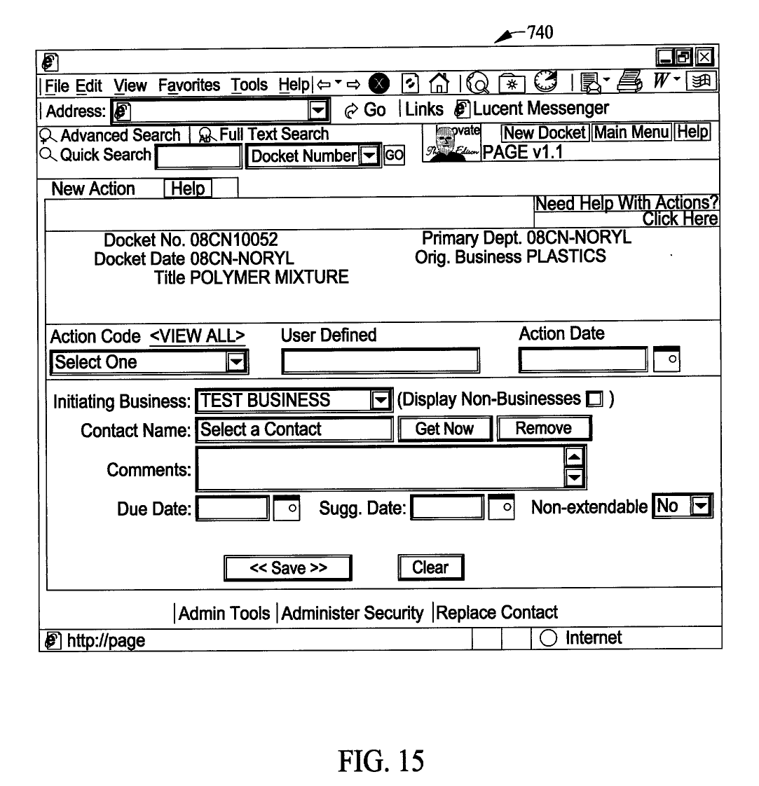

FIG. 15 is an example embodiment of a user interface 740 displaying a New Action page for a specific docket within PACS 10 (shown in FIG. 1). In the example embodiment, an action is defined as an event that takes place at a specific time. Actions are managed by PACS 10. Actions are often related to a filing within a docket.

In the example embodiment, actions can be classified as “snapshot actions”, “status actions”, or “due actions.” Snapshot actions are one-time events with no future actions needed. An example of a snapshot action is payment of an issue fee on a certain date for a specific docketed matter. Due actions require an additional action to complete. An example of a due action may be that an Office Action from the USPTO for a specific docketed matter requires a response by a certain date. PACS 10 enables a user to manage, schedule, and notify users of due actions.

Status actions change the status of dockets, U.S. filings and international filings. The docket status should be changed by adding an action when a docket becomes Inactivated, Filed, Consolidated, or when the Disclosure is Published. The U.S. Filing Status and International Filing Status is changed by creating an action from a drop down list including: Abandoned, Issued, Re-Issued, Filed, Application Deferred, EPC Granted, Opposition Appeal, Issued, PCT Chapter I, Dropped, Expired, Application Under Exam, Under Opposition, PCT Phase Completed, and PCT Chapter II. The status of the record will be derived from the last chronological status action entered.

In the example embodiment, to create an action, a user needs a source document or knowledge of an event; a docket number, a patent number, or a serial number to docket the event; the name of the filing or filing number if the action relates to a filing; and a person responsible for the action. Actions are added through user interface 740. User interface 740 is accessible by clicking on an Add Action link shown on docket details user interface 440 (shown in FIG. 8) near Disclosure Action table 484 or Filing Action Listing section, U.S. Filing Details (shown in FIG. 11) or International Filing Details (shown in FIG. 14). Once user interface 740 is displayed, a user enters the appropriate PA information into the provided data fields for the specific docketed matter.

In the example embodiment, most actions are associated with a filing in PACS 10. Properly aligning an action to a filing will more accurately establish a history of the filing and the current condition of the filing. If an action relates to a disclosure, then it belongs in the docket level of PACS 10. If, however, an action relates to a filing, then the action belongs in the filing. Moreover, a user must consider foreign filings and other prosecutions in a docket when docketing an action. Actions should only be docketed against a disclosure when they apply to the entire disclosure. For example, if a patent is being abandoned, the action belongs with the filing you are abandoning.

In the example embodiment, the term “snapshot” or “status action” indicates that a recorded action is complete as entered. “Due” actions require additional action to address or complete the action. To become a snapshot action or status action, a user must enter an action date when adding the action to PACS 10 and leave the Due Date data field blank. To become a Due action, the user enters the Action Date and the Due Date.

Certain actions lend themselves to one-time snapshot status while others tend to suggest a future action is needed to address or complete the action. PACS 10 also utilizes action codes for reporting purposes. In the example embodiment, action codes that are snap actions include at least one of amendment/response, inactivated, issued, open, information disclosure statement (IDS), filing receipt, abandoned, transfer docket, and extension of time. Action codes that are due actions include at least one of maintenance fee, office action, notice of allowance, final office action, notice of abandonment received, and examiner's amendment.

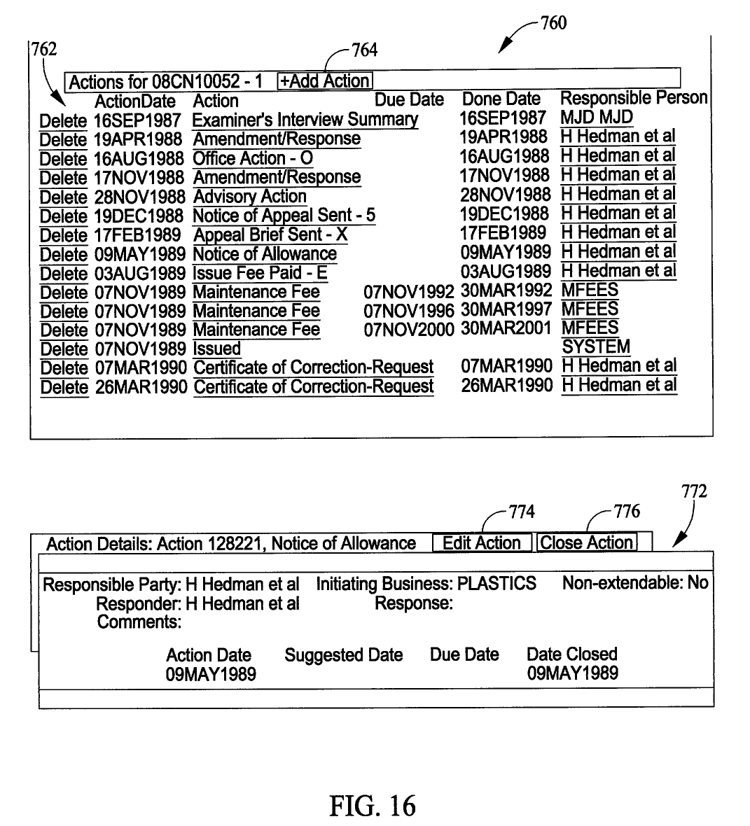

FIG. 16 is an example embodiment of a user interface 760 displaying an Actions table and an action details page for a specific docket within PACS 10 (shown in FIG. 1). Actions tables 762 are provided on the Docket screens (shown in FIG. 8), the U.S. Filing screens (shown in FIG. 11), and the International Filing screens (shown in FIG. 14). The Action table includes at least one of an Action Date column, an Action column, a Due Date column, a Done Date column, a Responsible Person column, and an Add Actions link 764. The Action Details are displayed when the user clicks on an Action in the Actions table.

User interface 760 also displays an Action Details section 772 that includes PA information including at least one of an action code, an action date, a date closed, an initiating business, a Responsible Party, a suggested date, a due date, a Non-extendable data field, a comments data field, a response, and a responder name. User interface 760 also displays an Edit Action button 774 and a Close Out button 776.

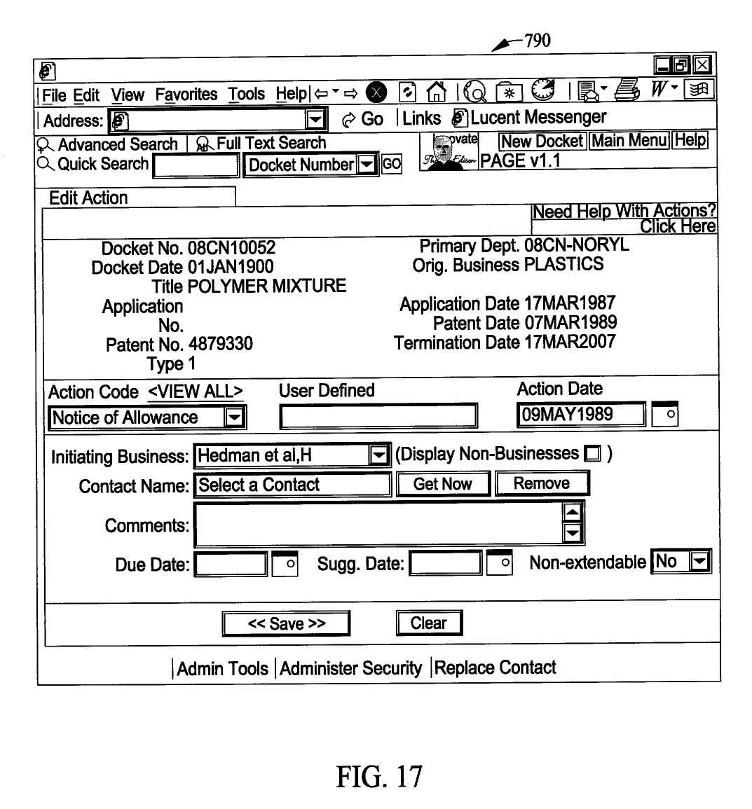

FIG. 17 is an example embodiment of a user interface 790 displaying an edit actions page for a specific docket within PACS 10 (shown in FIG. 1). A user accesses user interface 790 by clicking Edit Action button 774 on user interface 760 (shown in FIG. 16). User interface 790 enables a user to correct or update information entered through add action user interface 740 (shown in FIG. 15). In the example embodiment, actions may be edited at any time, even if the action is “closed.”

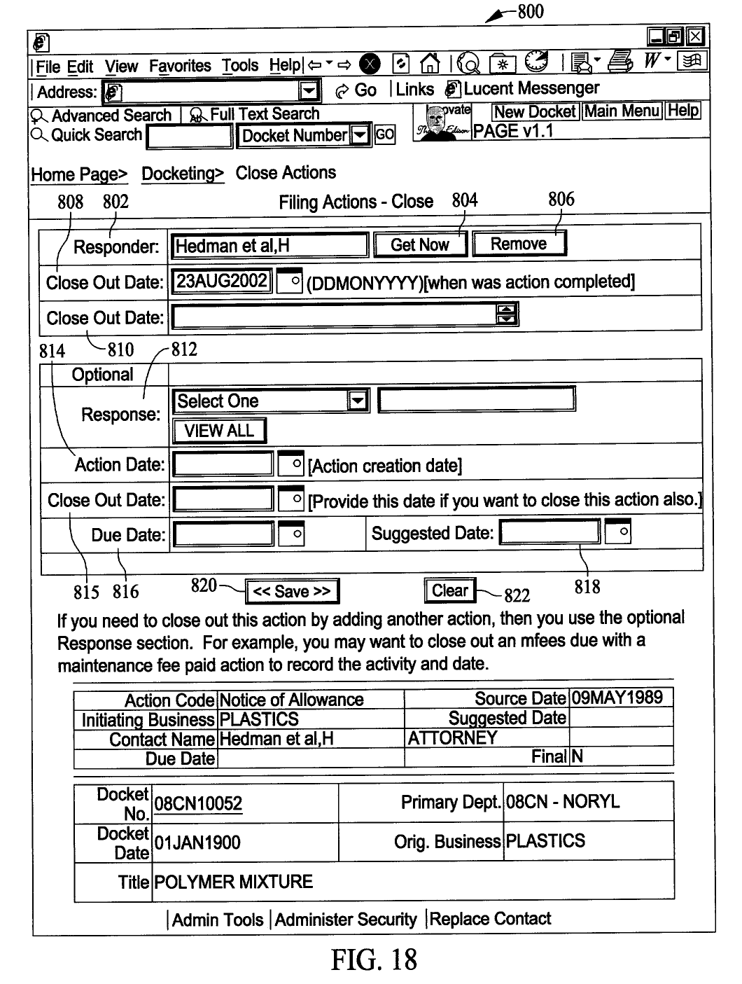

FIG. 18 is an example embodiment of a user interface 800 displaying a close out actions page for a specific docket within PACS 10 (shown in FIG. 1). A user accesses user interface 800 by clicking Close Action button 776 on user interface 760 (shown in FIG. 16). In the example embodiment, an action is considered closed once a response date is entered for the action. Response dates are added to an action through user interface 800, which can be further accessed by at least one of: (i) selecting a close link in one of the action listing sections in the docket details user interface 440 (shown in FIG. 8); and (ii) selecting a close link in a docket due report.

User interface 800 displays PA information for a specific docketed matter. More specifically, user interface 800 displays at least one of a Responder data field 802 with a Get Now button 804 and a Remove button 806, a Close Out Date data field 808 with a corresponding calendar, and a Comments data box 810. User interface also displays an optional section that includes a Response pull-down list 812 containing a favorites list of actions and a corresponding View All link, an Action Date data field 814 with a corresponding calendar, a Close Out Date data field 815 with a corresponding calendar, a Due Date data field 816 with a corresponding calendar, a Suggested Date data field 818 with a corresponding calendar, a Save button 820, and a Clear button 822. The favorites list of actions is specific to each user's business. The View All link displays all actions in the pull-down list. User interface 800 also displays certain PA information in tabular form near the bottom of the page.

The optional area displayed on user interface 800 is an optional data entry section that enables a user to close out an action by adding another action. In the example embodiment, closing out an action by adding another action may arise in at least one of the following circumstances: (i) closing a fees due action with a fees paid action to create a payable history; (ii) extending a fees due action for an additional period; and (iii) extending any action with an additional action in an effort to create additional context or history for future users of PACS 10.

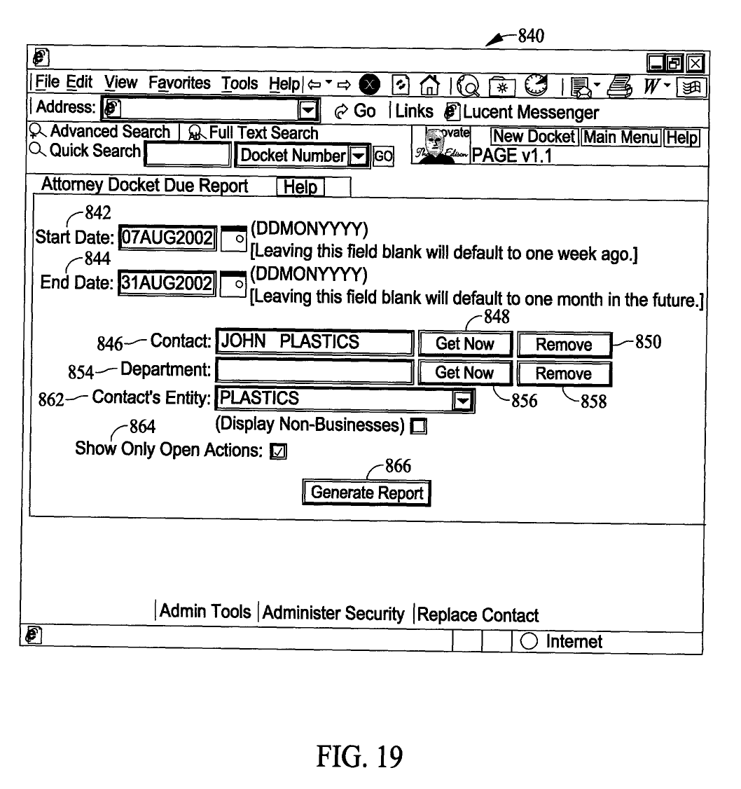

FIG. 19 is an example embodiment of a user interface 840 displaying an attorney docket due report input page within PACS 10 (shown in FIG. 1). PACS 10 generates a plurality of reports relating to PA information, filings, and scheduling. User interface 840 displays a summary of outstanding actions organized according to at least one of an Entity, a Contact, and a Department. User interface 840 displays at least one of a Start Date data field 842 with a corresponding calendar, an End Date data field 844 with a corresponding calendar, a Contact data field 846 with a corresponding Get Now button 848 and a Remove button 850, a Department data field 854 with a corresponding Get Now button 856 and a Remove button 858, a Contact's Entity pull-down list 862 with a link to see entire pull-down list, a Show Only Open Actions check box 864, and a Generate Report button 866.

In the example embodiment, the start date and the end date are not required information. However, if they are not entered, the system will default the range to one week prior and one month after the date of entry. The Business displayed in Contact's Entity pull-down list 862 will be default pre-populated with the user's business. The report filters out actions from filings having a Dropped status.

Additional report filters can also be used in PACS 10. Additional report filters allow for searching by Department, and for all actions, not just the actions that are due. More specifically, a Start Date filter will filter the report such that the report includes action dates greater than the date entered. An End Date filter will filter the report such that the report includes action dates prior to the date entered. A Department filter will filter the report such that the report includes actions by department. A Show Only Open Actions filter will filter the report such that the report includes only open actions.

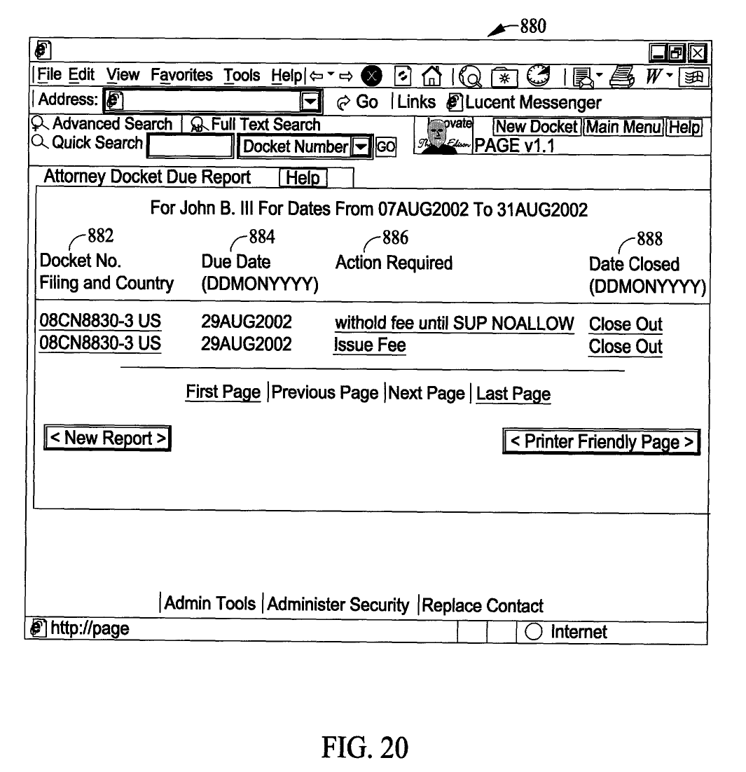

FIG. 20 is an example embodiment of a user interface 880 displaying an attorney docket due report output page within PACS 10 (shown in FIG. 1). PACS 10 generates user interface 880 after a user enters filter information through user interface 840 (shown in FIG. 19) and clicks on Generate Report button 866. User interface displays a table of information that includes at least one of a Docket Number column 882, a Due Date column 884, an Action Required column 886, and a Date Closed column 888. Each link provided below Docket Number column 882 provides access to the filing details for that docket. The Due Dates listed in Due Date column 884 are from the action in question. Clicking on the links displayed under Action Required column 886 will display the Action Details listing (shown in FIG. 16) for the specific action. Once the specific action is displayed, a user can edit or close the action out. Due Date column 884 displays the date an action was closed or links to close the action out. A user may close out an action by clicking on the Close Out link under the Date Closed column.

PACS 10 also enables a user to generate other reports. The reports that a user can generate through PACS 10 are for both filings and dockets. The reports may be accessed through home page user interface 300 (shown in FIG. 5) in Reports section 330. The reports accept a plurality of runtime parameters and a plurality of criteria, which results in providing a desired output consistent with user requests. The reports generated by PACS 10 include at least one of the following:

Contracts Information Report (DD882 Information)

A DD882 Information Report displays at least one of a docket number, a serial number, a status, a filing date, a filing country, U.S. filed, a title of invention, a license, inventors, and a patent number. The results are filings corresponding to a particular contract. The criteria requires the user to enter the contract number desired from a drop-down list.

Invoice Tracking Report

An Invoice Tracking Report displays at least one of a docket number, an invoice date, an invoice number, an entity, a payment due date, a payment date, an invoice amount, an item description, a filing serial number, and an item amount. The results are invoices corresponding to a particular docket number, invoice number, date range or vendor. The criteria requires the user to enter the docket number, invoice number, date range or vendor from an alphabetic list of vendors.

Patent Administrative Record (PAR) Report

A PAR Report displays docketing information, Inventor information and Filing information. The docketing information displays at least one of a docket date, a status, title, an abstract, a rating priority, an attorney, a foreign filing sponsor, a contract number, a lab technology group, alternate dockets and keywords. The inventor information is provided for the docket and the filings. It displays at least one of name, address, citizenship, occupation, social security number and employee status. The filing information displays at least one of filing type, application number, filing date, attorney, assignment reels and an indication of foreign filing. The results are the docket information, inventor information, and U.S. filing information for a docket. The criteria requires the user to enter the docket number.

Actions Report

An Actions Report displays at least one of a docket number, a contact, a lab/technology group, an action, a serial number, and a date range of the report. The results are the open actions for each attorney or for each lab/technology group for a given date range. The criteria requires the user to enter the docket number, contact, lab/technology group, action, serial number and/or date range.

Patent Portfolio Review Report

A Patent Portfolio Report is a file status report and provides the user with at least one of a portfolio administration cost, an application prosecution cost, and a maintenance cost for the chosen dockets. The inputs from the user include at least one of a department code for which the report is to be generated, a status year, and an indication of whether inventors and the abstract are to be included. The report gives the total internal costs for each application and patent excluding the U.S. filings and patents per docket that is foreign filed and for which the corporation is the payor. This calculation takes into consideration the percentage distribution in the foreign filing sponsor. The Report contents include at least one of:

| Field Name | Field Description |
|---|---|
| Cty | Country Code |
| Application No. | Application number |
| Appl date | Application date |
| Patent Num | Patent number |
| Patent date | Patent date |
| Termin date | Termination date |
| Cnt date | Count date |
| Assignee | Assignee |
| Status | Status |
| Annual chg | Annual charges |
| Total Docket Costs | Total Docket Costs |
| Inventors | Inventors |
| Abstract | Abstract |

Patent Applications Filed Reports

A Patent Applications Filed Report displays at least one of a docket number, a prosecuting attorney for the filing, a lab/technology group, a filing type, a USPTO application number, a filing date, and inventors. The results are filings where a filing date is between a date range provided for a business or lab/technology group. The report may also be run for all businesses. The criteria include at least one of: filing date range, business or lab/technology group, and an indication of whether inventor information is to be included.

Appeal Briefs Filed Reports

An Appeal Briefs Filed Report displays at least one of a docket number, a filing number, a lab/technology group and an action contact where a filing has an Appeal Brief Action with an action date between the date range provided, and where the docket's Lab/Technology Group is equal to the Lab/Technology Group provided. If a business is specified, then that business is compared to an initiating business of the action. The criteria include at least one of: Appeal Brief Action, Action Date, Docket Lab/Technology Group, and Action's Business Initiating Action.

Notices of Appeal Reports

A Notices of Appeal Report displays at least one of a docket number, a filing number, a lab/technology group and an action contact from filings where a Notice of Appeal action exists having an action date in between the time specified. The Lab/Technology Group is compared to the docket's, and the business, when provided, is compared to the initiating business of the action. The criteria include at least one of: Notice of Appeal, Action Date, Docket Lab/Technology Group, and Action's Business Initiating Action.

Amendments/Responses Reports

An Amendments/Responses Report displays at least one of a docket number, a lab/techology group, and an action contact from U.S. filings where an Amendment/Response action exists having an action date in between the time specified. The criteria require the user to select a Business and date range for the Amendment/Response.

Pending Applications Report

A Pending Applications Report displays at least one of a count, by lab/technology group or attorney, of U.S. filings of known type (excluding the null type filings) in dockets that have not been dropped, inactivated or “issued” where the filing has not been dropped, inactivated or issued, and where the filing has either an application date or number and a null patent date and null patent number. The report also excludes filings that have at least one of a Notice of Abandonment action, an Inactivated action, and an Abandoned action. The business is compared to the filing business. When an attorney option is selected, the count is for prosecuting attorneys of the filings. The criteria requires the user to select a Business and an indication if the report will be run by Component or by Attorney.

Patents Issued Reports

A Patents Issued Report displays at least one of a docket number, a lab/technology group, a patent date, a USPTO application number and a patent number from U.S. filings where a patent number exists, an Issued action exists and where the patent date is in between the time specified. If an Inventor check box is selected, a plurality of inventors for the filing are pulled and displayed. The user is required to enter the date range, the Business and an indication of whether inventors are to be included in the report.

Applications Allowed Reports

An Applications Allowed Report displays at least one of a docket number, a filing number, a Lab/Technology Group, a USPTO application number, a patent number and an action contact from U.S. filings where a Notice of Allowance action exists having an action date in between the time specified. When specified, the business is compared to the filing business of the filing and the initiating business of the action (inclusive). The criteria include at least one of: Notice of Allowance, Action Date, Filing Business, and Action's Business Initiating Action.

Applications Abandoned Reports

An Applications Abandoned Report displays at least one of a Lab/Technology Group (from Docket), an Action Contact, a docket number and a USPTO application number. The results are all U.S. filings with an abandoned action from departments belonging to a specified business, where an abandoned action falls in between the dates provided. If a Lab/Technology Group is specified, then only those dockets associated with that Lab/Technology Group are included. The criteria include at least one of: Abandoned Action, Action Date, and Docket Lab/Technology Group.

Dockets Inactivated

A Dockets Inactivated Report displays at least one of a lab/technology group, an action contact and a docket number. The results are all dockets that have an Inactivated status from departments belonging to a specified business, where the inactivation status falls in between the dates provided. The sum of all the inactivated dockets is also provided. If a Lab/Technology Group is specified, then only those dockets associated with that Lab/Technology Group are included. The criteria include at least one of: Business or Lab/Technology Group and a date range.

Expired Patents Reports

An Expired Patents Report displays at least one of a docket number, a lab/technology group, and a patent number. The results are all patents that have an expiration date during the date range requested and that are from departments belonging to a specified business. The sum of all of the expired patents is also provided. If a Lab/Technology Group is specified, then only those dockets associated with that Lab/Technology Group are included. The criteria include at least one of: Business or Docket Lab/Technology Group and a date range.

Transferred Patents Reports

A Transferred Patents Report displays at least one of a docket number, a filing number, a Lab/Tech Group, a patent number, a USPTO application number where a docket has a Transfer Docket action with an action date between the date range provided, and a USPTO application number where the docket's Lab/Tech Group is equal to the one provided. If a business is specified, then that business is compared to the initiating business of the action as well as the filing business. The criteria include at least one of: Transfer Docket, Action Date, Docket Lab/Tech Group, and Action's Business Initiating Action.

Patent Activity by Attorney Report

The Patent Activity Report by Attorney displays at least one of a contact and counts per month and year-to-date for total U.S. applications filed, total U.S. amendments prepared, total U.S. original applications filed, total U.S. appeal briefs and total U.S. applications abandoned on a given date and for a specified business. The user is required to select a business and date to run the report.

Monthly Statistics Summary Report

The Monthly Statistics Summary Report displays at least one of a lab/technology group and a count of dockets opened, U.S. applications filed and U.S. patents issued per month and year-to-date by Lab/Technology Group for a specified month and year. The user is required to select a business, a month and year to run the report.

Statistical Summary of Patent Activity

The Statistical Summary of Patent Activity Report displays at least one of a lab/technology group, a count of dockets opened, inactivated, rated to file, transferred and all others for a month and year specified for a Lab/Technology Group, a count of U.S. applications filed, pending, abandoned and issued for a month and year specified for a Lab/Technology Group, a count of U.S. amendments and appeal briefs filed for a month and year specified for a month and year specified for a Lab/Technology Group. The user is required to select a business, a month and year to run the report.

International Active (MQ15A) Reports

PACS 10 also generates a report referred to as an MQ15A report. The MQ15A Report is a file status report for international applications and patents, and provides the user with at least one of an annual charge the dockets in a specified Lab/Technology Group or Business for which the corporation is the payor. The report can be run on future dates based on the current portfolio to give the user projected costs. The costs are standardized internal costs that are charged for prosecution and annuities. The inputs from the user include at least one of a Lab/Technology Group for which the report is to be generated and a status year. If the department code is left blank, the report is generated for all the departments. This calculation takes into consideration the percentage distribution between the primary department and the alternate department in the foreign filing sponsor.

The MQ15A Report contents include at least one of:

| Field Name | Field Description |
|---|---|
| Cty | Country Code |
| Docket Number | Docket Number |
| Application No. | Application number |
| Appl date | Application date |
| Patent Number | Patent number |
| Patent Date | Patent date |
| Agt | Prosecuting attorney |
| Adm | Administrating attorney |
| Termin date | Termination date |
| Cnt date | Count date |
| Lab/Tech Group | Lab/Tech Group |
| Assignee | Assignee |
| Status | Status |
| Title | Title |
| Annual Charge | Annual charges |
| Total costs | Sum of charges for each filing per docket |
| Primary Department | First department listed as a Foreign Filing |
| | Sponsor |
| Alt Dept | Alternating department listed as Foreign |
| | Filing Sponsor |
| Inventors | Inventors |
| Total Costs for all Dockets | Sum of all docket costs per Department |
| in Department | |

Billing (MQ15B) Reports

PACS 10 also generates a report referred to as an MQ15B report. The MQ15B Report is a billing report for international applications and patents, and provides a plurality of costs for the chosen department or business for the year or by quarter. The report can be run on future dates based on the current portfolio to give the user projected costs. The inputs from the user include at least one of a department code for which the report is to be generated or a business, a status year, and a quarter of a year for which the report is to be generated or the entire year. If the department code is left blank, the report is generated for all the departments.

The MQ15B Report provides at least one of the portfolio administrative fee, application prosecution fees, and the maintenance fees for all of the dockets for which the corporation is the payor within the selected Lab/Technology Group or business. This calculation takes into consideration the percentage distribution between a primary department and an alternate department. The costs are standardized internal costs that are charged for prosecution and annuities.

The MQ15B Report contents include at least one of:

| Field Name | Field Description |
|---|---|
| Count | Number of patents or applications for |
| | which company is payor |

MQ15C Reports

PACS 10 also generates a report referred to as a MQ15C report. The MQ15C Report provides a detailed listing of all U.S. patents pertaining to the department specified which are due for renewal in a specified time period. The input from the user is the time period. The department code, whose dockets are to be considered, is also accepted as input. If the department code is left blank, the report is generated for all the departments together. The details for all the dockets whose 3 years begin within the search request date are displayed.

The MQ15C Report contents include at least one of:

| Field Name | Field Description |
|---|---|
| Appl'n Number | Application number |
| Appl'n date | Application date |
| Patent Number | Patent number |
| Patent Date | Patent date |
| Due Date | Date Maintenance Fee is due |
| Docket no. | Docket number |
| Department | Primary department |
| Contact Name | Contact Name for paying Maintenance Fee |

MQ20 Reports

PACS 10 also generates a report referred to as an MQ20 report. The MQ20 Report is an IPO billing report and includes a plurality of billed costs for the department for which MQ15B report was generated. A billing quarter for which the report is to be generated is taken as input from the user. If the user requests, an EDI billing file can also be created. An output includes the billed costs for the department. A plurality of billed costs are taken from a plurality of annual charges of the MQ15B report.

The MQ20 Report contents include at least one of:

| Field Name | Field Description |
|---|---|
| Sponsor code | Primary Department Code |
| Sponsor Name | Primary Department Name |
| Credits | |
| Debits | |
| Billed | |

MQ25 Reports

Another report generated by PACS 10 is referred to as an MQ25 report. The MQ25 Report lists all the dockets for a particular country. A country code for which the report is to be generated is taken as input from the user. If the country code is left blank, the report is generated for all the countries together. Depending upon the country inputted, the various dockets, which are filed in that particular country, are outputted. Dockets are classified according to whether the corporation is the payor.

The MQ25 Report contents include at least one of:

| Docket no. | Docket Number |
|---|---|
| Type | Type |
| Title of Invention | Title of invention |
| Appln. Date | Application date |
| Appln. No. | Application number |
| Patent Date | Patent date |
| Patent No. | Patent number |
| Assignee | Assignee |
| Agent | Prosecuting attorney |
| Term. Date | Termination date of the patent |
| Status | Status of the patent or application |
| License | Indication of whether the application or |
| | patent is licensed |
| Worked | Indication of whether the patent has been |
| | worked |

MQ26 Reports

PACS 10 also generates a report referred to as an MQ26 report. The MQ26 Report lists all the dockets for a particular department. A department code and year for which the report is to be generated is taken as input from the user. If the department code is left blank, the report is generated for all the departments together. Depending upon the department inputted, the various dockets, which are filed in that particular department, are outputted. Dockets are classified according to whether the corporation is payor.

The MQ26 Report contents include at least one of:

| Field Name | Field Description |
|---|---|
| Appln. No. | Application number |
| Appln. Date | Application date |
| Patent no. | Patent number |
| Patent date | Patent date |
| Title of Invention | Title of invention |
| Docket no. | Docket number |
| Department | Primary department |
| Term. Date | Termination date |
| Assignee | Assignee |
| Country | Country of filing |
| Type | Type of application or patent |
| Status | Status of application or patent |
| Agent | Prosecuting attorney |
| Payor | Owner of patent or application |
| License | Indication of whether the application or |
| | patent is licensed |
| Worked | Indication of whether the patent has been |
| | worked |

MQ29 Reports

Another report generated by PACS 10 is referred to as an MQ29 report. The MQ29 Report is a foreign maintenance report. The output is organized by country. The country, year, and month for which the report is to be generated will be taken as input from the user. If the user leaves the month field blank the report is generated for the whole year. This report prints out the docket details for those dockets for which annuity payment is due in the month specified for the specified country.

The MQ29 Report contents include at least one of:

| Field Name | Field Description |
|---|---|
| Appl No. | Application number |
| Appl date | Application date |
| Patent no. | Patent number |
| Patent date | Patent date |
| Docket no. | Docket number |
| Count Date | Date from which annuity is determined |
| Term date | Termination date |
| Assignee | Assignee |
| Status | Status |
| Type | Type |
| Agent | Prosecuting Attorney |
| License | Indication of whether the application or |
| | patent is licensed |
| Worked | Indication of whether the patent has been |
| | worked |

MQ51B Reports

PACS 10 also generates a report referred to as an MQ51B report. The MQ51B Report provides a plurality of details regarding a plurality of recently dropped dockets. The inputs from the user include at least one of a country code, a start date, and an end date. The docket details for the dockets dropped in the date range given will be outputted.

The MQ51B Report content includes at least one of:

| Field Name | Field Description |
|---|---|
| Appl No. | Application number |
| Appl date | Application date |
| Patent no. | Patent number |
| Patent date | Patent date |
| Docket no. | Docket number |
| Department | Primary department |
| Ter date | Termination date |
| Assignee | Assignee |
| Count date | Count date |
| Type | Type |

PAMTAP Reports

The PAMTAP Report is an annuity report for synchronizing data with an annuity service. It includes a dropped section and an updated section. The user inputs a date range. Generally, the date range includes the date from which the report was last run to the present date, but any date range may be used. The system retrieves all new data entered into the system during the specified date range and separates the data into a dropped section or an update section. The dropped section includes all records that do not match the criteria for annuity payment including: dropped status, payor code change from the company code, a U.S. filing and a U.S. patent. The dropped section displays at least one of: Docket Number, Country, Application Number, Patent Owner, Application Date, Patent Number, Patent Date, Prosecuting attorney, Inventor, dropped status, termination date, title of invention and comments.

The updated section includes all data during the specified date range on records that match the criteria for annuity payment including: publishing data, international application number, international application date, international patent number, international patent date, status change to issue or under exam and creating an international filing. The update section displays at least one of: Docket Number, Country, Application Number, Patent Owner, Application Date, Patent Number, Patent Date, Prosecuting attorney, Inventor, title of invention and comments.

MQ55 Reports

PACS 10 also generates a report referred to as an MQ55 report. The MQ55 Report provides a list of deferred applications for any particular attorney. The attorney for which the report is to be printed and the year is taken as input from the user. The dockets which have the inputted attorney as their prosecuting attorney and their status as deferred applications, will be outputted.

The MQ55 Report content includes at least one of:

| Field Name | Field Description |
|---|---|
| Appl No. | Application number |
| Appl date | Application date |
| Docket no. | Docket number |
| Dept | Primary department |

Deferred Application by Department Reports

PACS 10 also generates a report referred to as a Deferred Application by Department report. The Deferred Application by Department Report provides a plurality of details regarding a plurality of deferred applications pertaining to the particular department. The input taken from the user is the department code and year. Those dockets that have their respective primary departments as the one inputted by the user and have the same status as deferred applications will be outputted.

The Deferred Application by Department Report content includes at least one of:

| Field Name | Field Description |
|---|---|
| Country | Country name |
| Year | Year that deferred applications are due for |
| | examination |
| Docket no. | Docket Number |
| Prim Dept | Primary department of Foreign Filing |
| | sponsor |

Bonus Awards Due Reports

The Bonus Awards Due Report displays at least one of a Lab/Technology Group, Docket Number, an indication of whether the inventor is a company employee, inventor name, and social security number. The user inputs a date range for awards due during the date range or indicates that all awards are to be viewed, selects a business and an indication of whether the report is limited to company employees. The results are a list of all dockets and inventors that are subject to an award or bonus during the specified data range.

Inventor Log Reports

The Inventor Log Report displays an Inventor Details section and the Log section. The Inventor Details section displays at least one of: Inventor Name, Inventor social security number, address, business, profession, citizenship, whether the inventor is an employee, a contact ID number, and a listing of Award types, award count and award amounts given to the inventor. The Log displays at least one of: Docket Number, Lab/Tech Group, Docket Date, Disclosure Status, Filing Country, Filing Date Issued Date, Filing Bonus Date and Issue Bonus Date. The results allow the user to review the contact information of the inventor and review the bonus award information for each docket the inventor is an inventor. The user accesses the report by selecting an inventor or selecting a business.

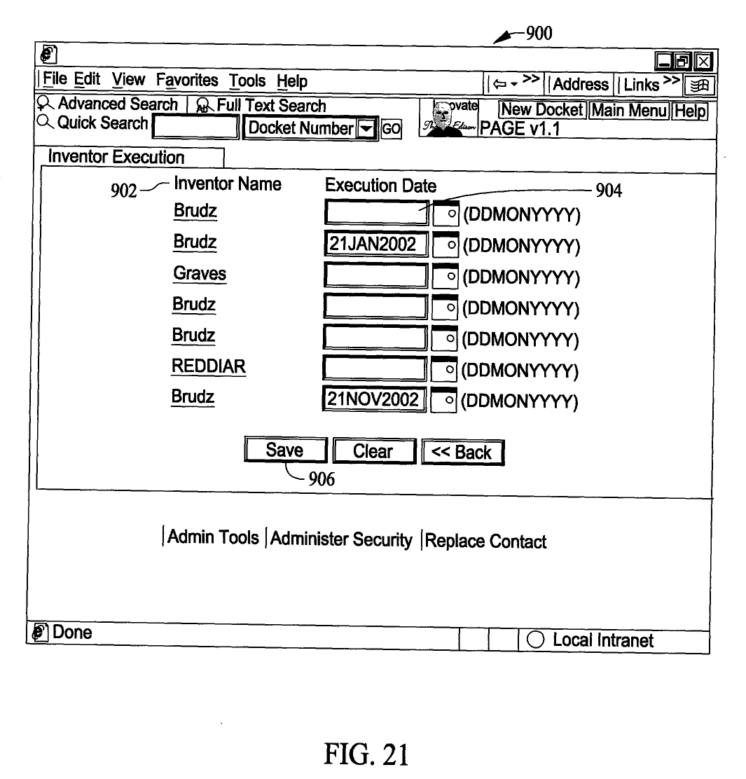

FIG. 21 is an example embodiment of a user interface 900 displaying an inventor execution date entry page within PACS 10 (shown in FIG. 1). Inventors entered into PACS 10 are considered a subset of contacts. When a contact is given the role of Inventor in a docket or filing within PACS 10, PACS 10 will enable a user to associate an execution date with that contact, and will expose that contact in a bonus module when the docket or filing is viewed. Reports can also expose an association of contacts to dockets and filings with the inventor role.

An execution of assignment papers can be recorded in several different places with PACS 10. At least one way to access user interface 900 is by clicking on an Inventor Execution Date link displayed on U.S. Filing details page 590 (shown in FIG. 11). User interface 900 displays a plurality of inventors under Inventor Name column 902 with an empty execution date data field 904 and a corresponding calendar next to each inventor name. An execution date is entered for each inventor who has signed an assignment. The remaining fields are left blank, and the user clicks on Save button 906 to record the information.

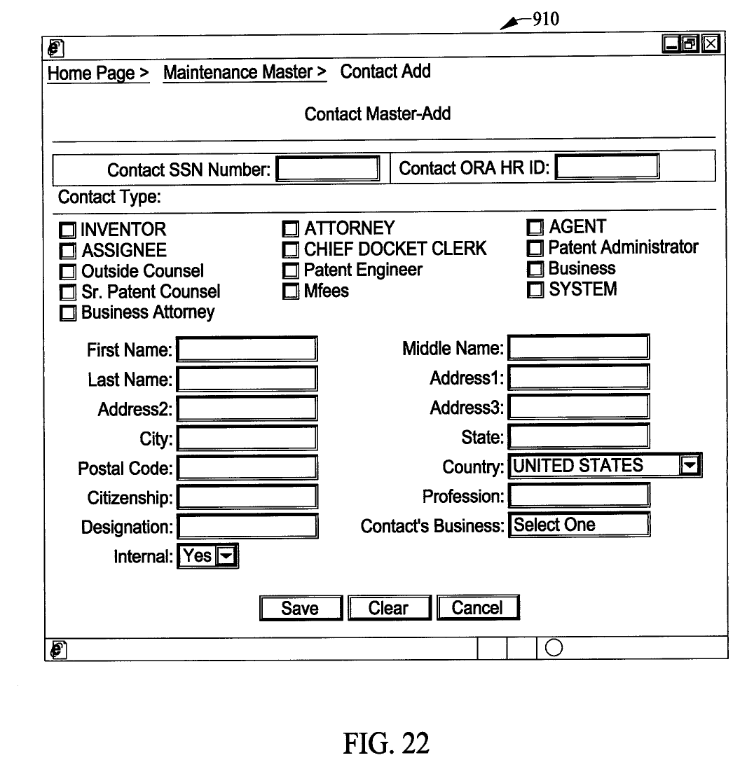

FIG. 22 is an example embodiment of a user interface 910 displaying a contact master-add page within PACS 10 (shown in FIG. 1). PACS 10 maintains contact information. The contact information can be entered through at least one of a plurality of data fields, a plurality of check boxes, and a plurality of pull-down lists displayed on user interface 910. User interface also enables a user to designate the role of the contact person by selecting one of a plurality of check boxes displayed on user interface 910.

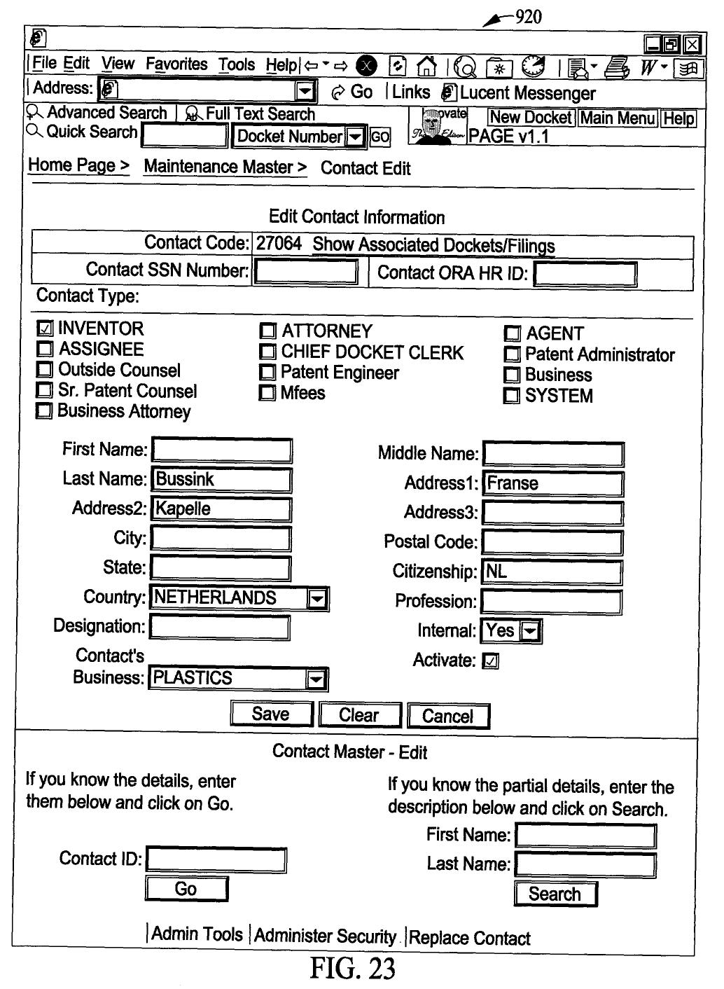

FIG. 23 is an example embodiment of a user interface 920 displaying an edit contact information page within PACS 10 (shown in FIG. 1). The contact information can be edited through at least one of a plurality of data fields, a plurality of check boxes, and a plurality of pull-down lists displayed on user interface 920.

PACS 10 includes an awards module for tracking awards activity in a patent operation. Awards are granted to inventors by a business to award the inventors for their work on a patent. To run the bonus module, a user accesses (i) an Awards Detail screen through the Awards section on U.S. Filing Details screen 590 (shown in FIG. 11) or (ii) clicks on the Administer Awards link (shown in FIG. 5).

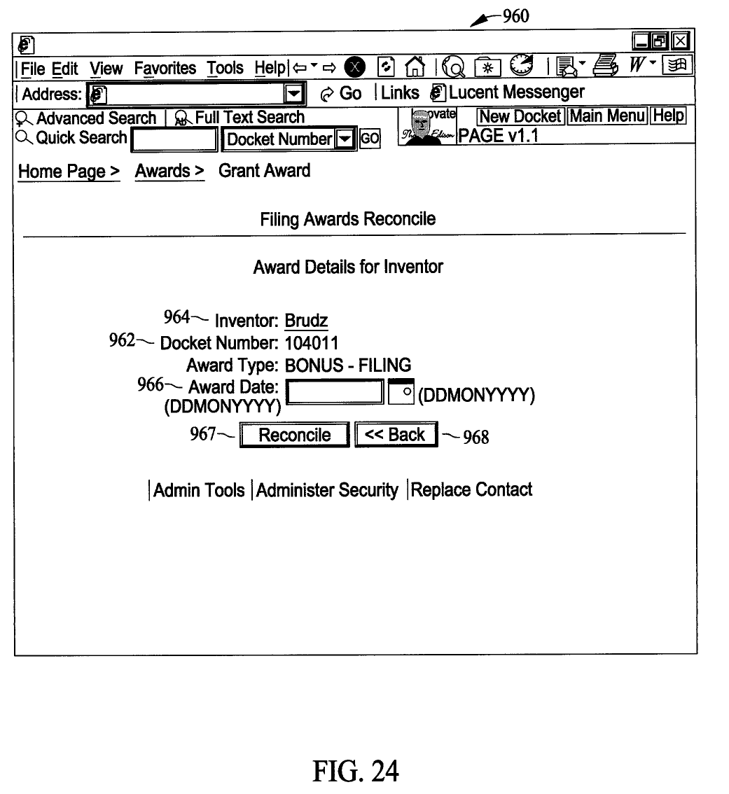

FIG. 24 is an example embodiment of a user interface 960 displaying an awards detail page within PACS 10 (shown in FIG. 1). User interface 960 is accessed through the Awards section on U.S. Filing Details screen 590 (shown in FIG. 11). User interface 960 displays at least one of a Docket Number 962, an Inventor Name 964, an Award Date data field with a corresponding calendar 966, an Award Type, a Reconcile button 967, and a Back button 968.

To assign an award to an inventor, a user enters the date into Award Date data field 966 and clicks on Reconcile Button 967. The user will be returned to the U.S. Filing Details screen and the Award Date will show under the Date column of the Awards section (shown in FIG. 11).

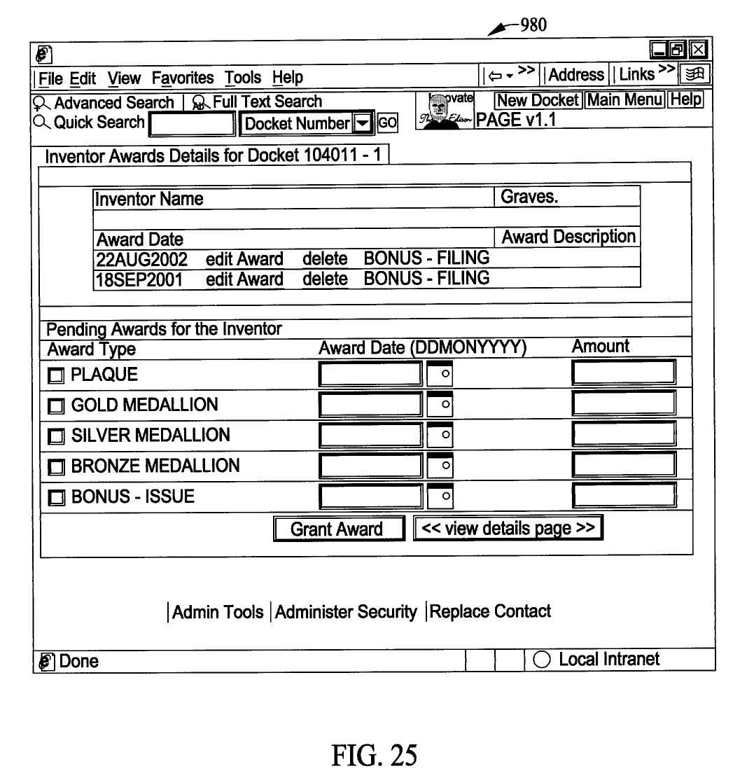

A user may edit awards and bonuses by clicking on the Edit Awards link under the Awards section of the U.S. Filing Details screen (shown in FIG. 11). By so doing, FIG. 25 will be displayed. FIG. 25 is an example embodiment of a user interface 980 displaying an Inventor Awards Details and Pending Awards page. The Inventor Awards Details section of user interface 980 displays at least one of: Inventor Name, Award Date column and an Award Description column. Each award under the Award Date column will have an Award Date or a Reconcile link, an Edit Award link and a Delete link. The user may: (i) reconcile the award, (ii) edit the award or (iii) delete the award. The user reconciles the award by clicking on the Reconcile link, which will take the user to the Award Details screen (shown in FIG. 24). The user may edit the award by clicking on the Edit Award link. A screen will come up (not shown), which will allow the user to edit the date of the award and/or the amount of the award and then submit the update by clicking the Update Award button (not shown). If the user selects the delete link, the award will be deleted.

The Pending Awards section of user interface 980 displays at least one of an Award Type column, an Award Date column, an Amount column, a Grant Award button and a View Details Page link. The Award Type column lists at least one of a Plaque, Gold Medallion, Silver Medallion, Bronze Medallion and a Bonus-Issue award. Each Award Type has a check box and an Award Date data field with corresponding calendar. The Bonus-Issue award also has a corresponding Amount data field. To grant the inventor a Plaque or Medallion, the user enters the date into the Award Date field, selects the Plaque and/or Medallion by clicking the check box and clicks the Grant Award button. The user will be returned to the U.S. Filing Details screen (shown in FIG. 11) and the Plaque and/or Medallion will be displayed under the Awards section for the Inventor.

To award a bonus, the user enters the date into the Award Date field, selects the Bonus-Issue award type by clicking the check box and clicks the Grant Award button. The user will be returned to the U.S. Filing Details screen (shown in FIG. 11) and the Bonus will be displayed under the Awards section for the Inventor.

The user may also access the bonus awards module by accessing the Administer Awards link 314 (shown in FIG. 5). A Bonus/Awards Module input screen (not shown) allows the user to select whether to administer awards at the docket level for disclosures or at the filing level. The user may administer awards and bonuses from (i) a specified date and business (ii) by docket numbers or docket groupings or (iii) by batch bonus interface. If the user selects a date and business and clicks an OK button (not shown), the results will be a Grant Awards report. The user may also access the Grant Awards report by providing a docket number of grouping of docket numbers. The Grant Awards report displays at least one of a docket number, a docket date, a U.S. filing, an application type, a title of invention, an application date, an inventor name column, an execution date column and a bonus/award grant column. The inventor name column lists each inventor associated with the docket or filing and any awards that the inventor has received for the invention and provides a Done check box. When a user is finished administering awards and bonuses for the inventor in the docket or filing, the user clicks into the Done box. In the Execute column, the date that the inventor executed the assignment is shown. If there is no date, an Execute link appears. The user may enter the execution date if desired by clicking the Execute link and providing the execution date as previously described. The bonus/award grant column provides dates that an award or bonus was given or a Grant link if an award or bonus is due or open. The user may grant an award or bonus by clicking on the Grant link and accessing a Pending Awards screen (shown in FIG. 25).

Alternatively, the user may select the Batch Bonus Interface to administer the awards and bonuses. A batch process allows for the monthly issuance of awards to inventors in large patent operations. The batch process only allows docket administrators an ability to add bonus awards for filings, and does not accommodate other awards such as medallions or plaques. The batch process facilitates a speedy process by focusing on the most time critical task in the bonus process.

To run the batch bonus interface, a user enters a Business through a Business pull-down list (not shown), selects a Batch Bonus Interface check box (not shown), enters a date from which the bonuses are to be administered from and then clicks on a OK button (not shown). The result is a report displaying at least one of: a docket number, a filing type, a filing number, an inventor, a social security number of the inventor, an execution column, a bonus amount column and a bonus date column. In the Execute column, the date that the inventor executed the assignment is shown. If there is no date, an Execute link appears. The user may enter the execution date if desired by clicking the Execute link and providing the execution date as previously described. The bonus amount column provides a text field for every inventor listed and an X (delete) button. The user fills in the bonus amount into the field. If the amount is wrong or the user wants to delete the amount, the user may click on the X (delete) button to remove the amount. The bonus data column is a date field to enter the date the bonus is given. It defaults to the date the user is accessing the report. The user clicks an Enter these Values button to commit the bonus amounts and date.

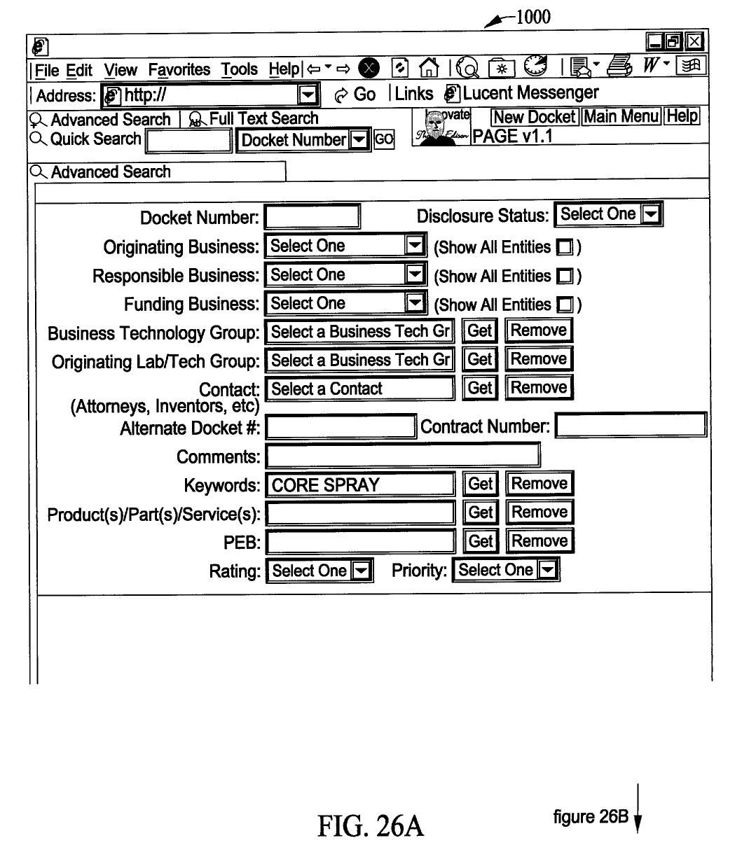

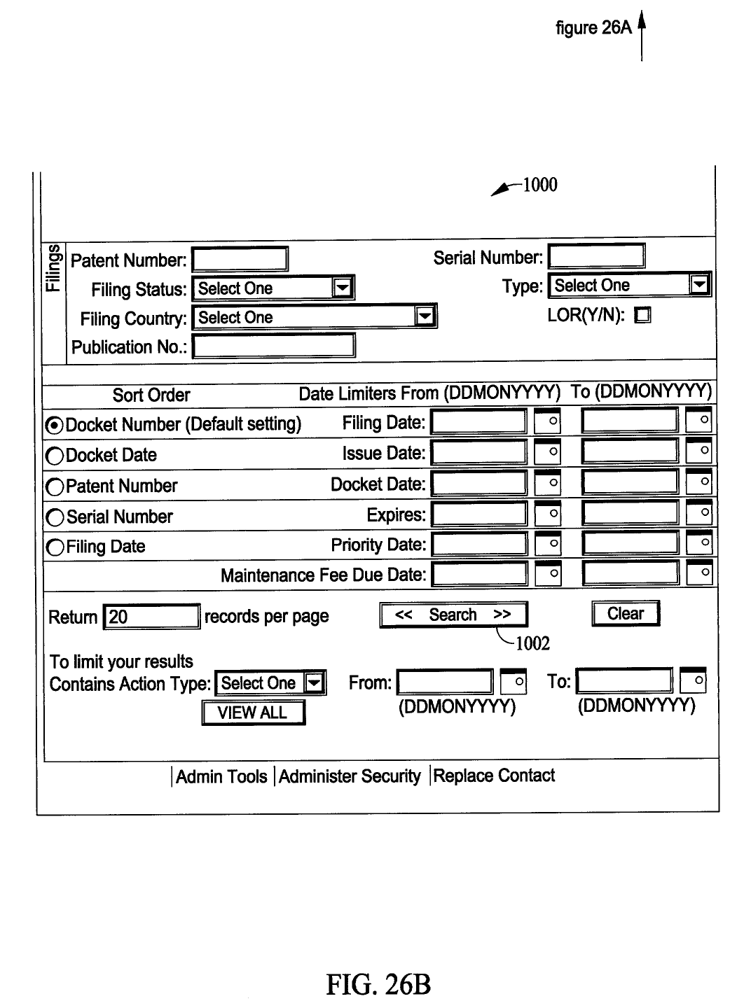

FIG. 26 is an example embodiment of a user interface 1000 displaying an advanced docket search input page within PACS 10 (shown in FIG. 1). PACS 10 enables a user to search for a specific docket or group of dockets by entering a plurality of specific information into user interface 1000. After entering the information into user interface 1000, the user clicks on a Search button 1002, and a search request is submitted.

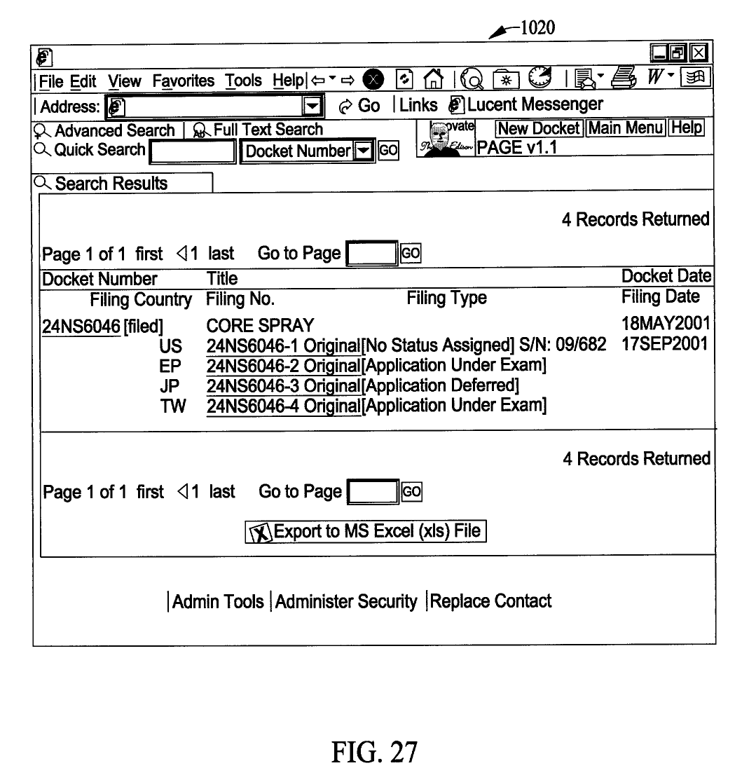

FIG. 27 is an example embodiment of a user interface 1020 displaying an advanced docket search results page within PACS 10 (shown in FIG. 1). User interface 1020 is generated after a user enters search information into user interface 1000 (shown in FIG. 26), and clicks on Search button 1002 (shown in FIG. 26). User interface 1020 displays in tabular form the results of the search. The search results display at least one of a docket number, country, filing number, filing type, docket date, filing date, application number, patent number, and filing status.

Users may also run quick searches in PACS 10 (shown in FIG. 1). A user enters a docket number or part of a docket number into a Quick Search field, selects Docket Number from a pull-down list and clicks a Go button. The search results display at least one of a docket number, a country, a filing number, a filing type, a docket date, a filing date, an application number, a patent number, and a filing status. Other quick searches may be run by entering a patent number or part of a patent number into the Quick Search field, selecting Patent Number from the pull-down list and clicking the Go button or entering an application number or part of an application number into the Quick Search field, selecting Serial Number from the pull-down list and clicking the Go button. The search results display at least one of a docket number, a country, a filing number, a filing type, a docket date, a filing date, an application number, a patent number, and a filing status.

PACS 10 also includes text search capabilities. To utilize text search capabilities, a user clicks on a Full Text Search link (shown in FIG. 5). A Full Text Search screen appears (not shown) with a Text Search Area field box. The user adds a word or string of text into the Text Search Area and clicks on a Search button. The results will be a record or records having a match to the selected word or string of text entered by the user. If no records are found having a match, the result will be no records.

PACS 10 includes a help section to help users effectively use the system, understand the fields and reports. The user accesses the help section by clicking on a Help link (shown in FIG. 5).

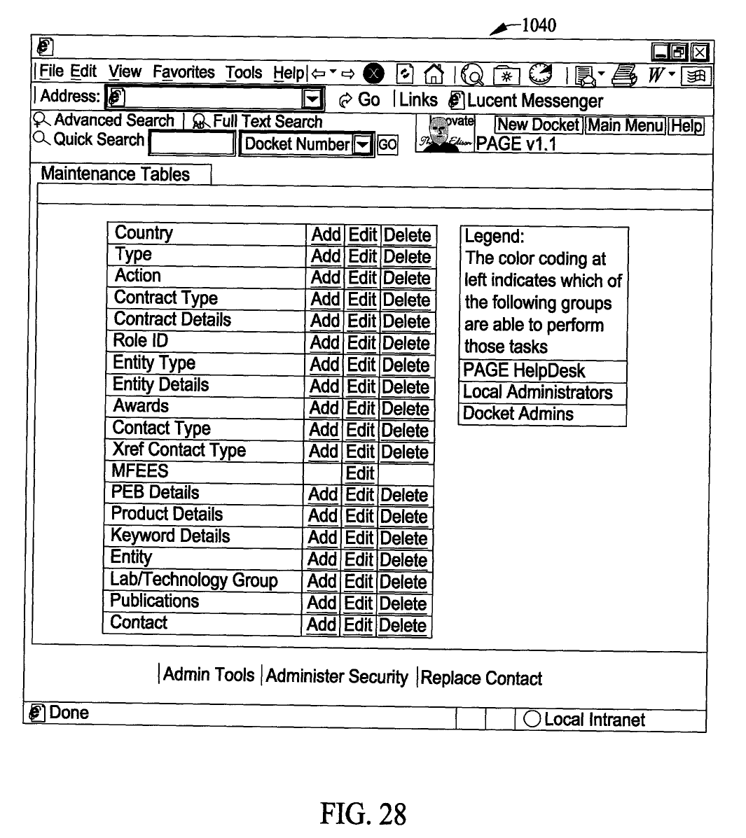

FIG. 28 is an example embodiment of a user interface 1040 displaying a Maintenance Tables page within PACS 10 (shown in FIG. 1). User interface 1040 is generated after a user clicks on Maintain Lookup Tables link 324 (shown in FIG. 5). User interface 1040 displays each table with an Add, Edit or Delete link and color coding for each table. The system maintains conformity of data through the use of drop-down lists, which are pulled from the maintenance tables. Information in the tables may be added to, edited or deleted, but only by specific groups of users. Providing limited access to the tables, allows the system to maintain the integrity of the tables and data in the system. In the example embodiment, some tables may be modified by Docket Administrators, some tables may be administered by local administrators and some tables may only be modified by a helpdesk. The tables are color-coded to show which tables may be modified by which groups of users. The tables include at least one of: a Country, a Type of Application, an Action, a Contract Type, a Contract Details, a Role ID, an Entity Type, Entity Details, Awards, a Contact Type, a Cross-reference Contact Type, Maintenance Fees, Patent Evaluation Board Details, Product Details, Keyword Details, an Entity, a Lab/Technology Group, Publications and a Contact.

To add to a table, an approved user clicks on the Add link and a screen will display (not shown) to allow the user to add an entry to the table. If the Edit or Delete link is selected, a screen will display (not shown) allowing the user to search for the entry to be edited or deleted. By selecting the entry, the user will be able to delete the entry or edit it.

The Maintenance Fee table provides internal amounts for international annuities that are used in a budget module to predict future costs, bill costs internally and run finance reports, such as MQ-15A, MQ-15B, MQ-20 and Patent Portfolio Review. The budget module includes other internal cost tables for prosecution costs and administrative costs that are also used to predict future costs, bill costs internally and run finance reports, such as MQ-15A, MQ-15B, MQ-20 and Patent Portfolio Review.

PACS 10 provides differing levels of security to the system based on individual users and user groups. The user groups include at least one of: an administrator, an award, different groups of in-house attorneys, different groups of docket administrators/clerks, Finance, Legacy, Helpdesk and Read Only. Each group has different access rights. In the example embodiment, a user in an award user group will be able to view social security numbers of inventors and administer bonuses and awards through the Bonus Award module. Docket administrators/clerks may create dockets and filings and edit dockets and filings. Security is also affected by the user's business. Docket administrators/clerks may only create and edit files specific to their business. Administrators have the same rights as Docket administrators/clerks with an additional ability to delete entire dockets or country filing records. The Administrator rights are also affected by the Administrator's business. An Administrator may only delete records associated with the Administrator's business. Some docket administrator/clerk groups and in-house attorney groups have rights to more than one business.

Security is administered by accessing Manage Users & Permissions link 326 (shown in FIG. 5). The link takes the user to a screen which allows the user to select from at least one of: a Group, a User, a Screen Permission and a Table Permission. Group allows an approved user to add a new group or delete a group. User allows an approved user to add a new user, delete a user or edit a user's security. When the user clicks on the User link (not shown), the user may either search for a user or enter a new user. To set up a new user, the user clicks Add a User link (not shown). A new user screen (not shown) displays at least one of a system-generated User Id number, a field for the User's employee ID number, a field for the user name, Business, Designation, URL, a checkbox for Export Control and a Group security section, which displays the current user groups with corresponding check boxes. The user must enter the employee's id number, user name and business. If the new user is subject to export control restrictions, the user checks the Export Control Required box. The user also associates the new user with appropriate user groups that are needed for the user to perform their job functions while using PACS 10 by clicking in the check box of a user group. A user may be assigned to a more than one user group. The permissions of the user will be determined by the business of the user, the user groups and whether the Export Control Required box is checked. All of the user fields are editable except the system-generated user ID.

A user that has an Export Control Required checkbox checked will not be able to access any abstracts in the system. A user who is an administrator and who has an Export Control Required checkbox checked will be able to provide access to other users, but only with Export Control restrictions.

Screen Permission and Table Permission allow approved users to change the levels of access and user group access to screens and tables.

PACS 10 allows a contact to be replaced by another contact in the system. Many times attorneys or docket clerks leave a company and their responsibilities need to be taken over by another attorney or docket clerk. When a user clicks the Replace Contact link (shown in FIG. 5), a Replace Contacts screen will display (not shown). The user may search for a contact, select the contact from a list, click on an Add to Old or Add to New button. The old contact is the contact that needs to be replaced and the new contact is the contact replacing the old contact. When the user selects a Replace Contact button (not shown), the system replaces the old contact with the new contact on all records as where the old contact is listed as a contact and in all actions where the action has not been completed. If an action has been closed out, the system will not replace the old contact with the new contact, but will leave the old contact.

PACS 10 therefore enables a business entity to manage PA information, provide PA information to multiple users within a business entity and authorized users outside the business entity, schedule and manage patent filings and patent related actions, and generate a plurality of reports relating to PA information. Additionally, PACS 10 enables a business entity to manage PA information including patent related filings and actions for both U.S. filed patent applications and foreign filed patent applications. By enabling a business entity to better manage PA information, PACS 10 facilitates the timely filing of responses in the prosecution of patent applications and facilitates reducing the amount of time spent on managing a patent portfolio for the business entity. Accordingly, PACS 10 facilitates reducing costs for the business entity.

While the invention has been described in terms of various specific embodiments, those skilled in the art will recognize that the invention can be practiced with modification within the spirit and scope of the claims.

What is claimed is:

1. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information;
providing PA information in response to an inquiry; and
providing a bonus module for tracking at least one of bonuses and awards assigned to each inventor.

2. A method in accordance with claim 1 further comprising providing at least one report relating to PA information on a multi-level basis to a predesignated party, the multi-level basis includes a plurality of levels from within the business entity including at least one of an individual patent application basis, a product basis, a technology basis, a business basis, a division basis, and a company basis.

3. A method in accordance with claim 2 wherein providing at least one report relating to PA information on a multi-level basis further comprises:
generating at least one of an Attorney Docket Due Report, an MQ15A Report, an MQ15B Report, a Bonus Awards Due Report, an Inventor Log Report, a Patent Portfolio Review Report, a Patent Administrative Record Report (PAR), an Updated Information for Annuity Payments Report (PAMTAP), a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report; and
transmitting to a predesignated party at least one of an Attorney Docket Due Report, an MQ15A Report, an MQ15B Report, a Bonus Awards Due Report, an Inventor Log Report, a Patent Portfolio Review Report, a Patent Administrative Record Report (PAR), an Updated Information for Annuity Payments Report (PAMTAP), a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report.

4. A method in accordance with claim 1 further comprising providing PA information in response to an inquiry on a multi-level basis selected by a user, the multi-level basis includes a plurality of levels from within the business entity including at least one of an individual patent application basis, a product basis, a technology basis, a business basis, a division basis, and a company basis.

5. A method in accordance with claim 1 further comprising providing a budget module for managing cost information relating to the business entity's patent assets, the budget module configured to generate at least one budget on a multi-level basis for the business entity wherein the at least one budget projects patent asset related costs for a selected level within the business entity for upcoming years.

6. A method in accordance with claim 1 further comprising:
providing export controls to restrict a user's access to only dockets assigned to the user;
providing export controls to restrict a user's access to only specific information included in a docket assigned to the user; and
providing PA information in response to an inquiry from a user subject to the export controls.

7. A method in accordance with claim 1 further comprising providing a schedule of upcoming tasks relating to PA information to a predesignated party.

8. A method in accordance with claim 1 wherein receiving PA information comprises receiving at least one of a docket number, a docket date, an originating business, a business technology group, an originating lab/technology group, a responsible business, an alternate docket number, a patent application title, a product/part/service description, an abstract, inventor information, prosecuting attorney information, contact information, a disclosure status, a prosecution priority rating, inventor assignment information, foreign filing information, a U.S. Patent and Trademark Office (USPTO) Serial Number, a Patent Number, Group Art Unit data, a recorded date, prosecution tasks, prosecution dates, patent expiration dates, and other information relating to patent assets of the business entity.

9. A method in accordance with claim 1 wherein receiving PA information comprises receiving PA information input through the client system for the business entity.

10. A method in accordance with claim 1 wherein receiving PA information comprises prompting a user to create a docket.

11. A method in accordance with claim 10 wherein prompting a user to create a docket further comprises prompting a user to create a docket that includes at least one of a docket date, an originating business, a business technology group, an originating lab/technology group, a responsible business, an alternate docket number, a title, a product/part/service description, an abstract, comments, a disclosure status, a rating, a contact name, a foreign filing sponsor, a URL name, and a contract type.

12. A method in accordance with claim 1 wherein updating the centralized database comprises prompting a user to edit a docket stored in the centralized database.

13. A method in accordance with claim 1 wherein updating the centralized database comprises prompting a user to add a filing to a docket stored in the centralized database wherein the filing includes at least one of a provisional patent application, an original patent application, a divisional patent application, and a continuation-in-part patent application.

14. A method in accordance with claim 13 wherein prompting a user to add a filing further comprises prompting a user to add a United States filing to a docket wherein the United States filing includes at least one of a serial number, a filing date, a patent number, an issue date, a filing business, a patent owner, a filing type, a filing status, a group art unit, an attorney docket number, a License of Right (LOR), a priority date, a priority country, a title, an abstract, a business method application indicator, recordation information, publication information, contract information, a contract due date, contact name/inventors data, expiration period data, an expiration date, a concurrent dockets filed docket number, a filing serial number, and remarks.

15. A method in accordance with claim 13 wherein prompting a user to add a filing further comprises prompting a user to add a Foreign filing to a docket wherein the Foreign filing includes at least one of a docket number, a filing country, a docket due date, an originating business, a lab/technology group, a title, an application number, a filing date, a patent number, a patent date, a filing business, a patent owner, a filing type, a filing status, a priority date, a priority country, a title, an Abstract, a License of Right (LOR), a business method application indicator, a publication type, a publication number, a publication date, a publication description, contact data, a contract number, a contract due date, a termination period, and remarks.

16. A method in accordance with claim 1 wherein updating the centralized database comprises prompting a user to edit a filing associated with a docket stored in the centralized database.

17. A method in accordance with claim 1 wherein updating the centralized database comprises prompting a user to perform at least one of:
add an action to a docket stored in the centralized database; and
edit an action to a docket stored in the centralized database.

18. A method in accordance with claim 1 wherein tracking PA information comprises:
tracking at least one of a plurality of dockets, a plurality of filings, and a plurality of actions; and
generating a schedule that includes dates and tasks to be performed relating to the plurality of dockets, the plurality of filings, and the plurality of actions to facilitate the business entity's compliance with U.S. and Foreign patent laws.

19. A method in accordance with claim 18 wherein generating a schedule further comprises transmitting the schedule to a predesignated party to facilitate management of the plurality of dockets, the plurality of filings, and the plurality of actions for the business entity.

20. A method in accordance with claim 1 wherein providing PA information comprises:
displaying information on the client system regarding at least one of a docket, a filing, and an action; and
receiving an inquiry from the client system regarding at least one of a specific docket, a filing, and an action.

21. A method in accordance with claim 1 wherein providing PA information comprises:
accessing the centralized database;
searching the database regarding the specific inquiry;
retrieving information from the database; and
transmitting the retrieved information to the client system for display by the client system.

22. A method in accordance with claim 1 further comprising connecting the client system and the server system via a network that includes one of a wide area network, a local area network, an intranet and the Internet.

23. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information;
providing PA information in response to an inquiry; and
providing a bonus module for tracking at least one of bonuses and awards assigned to each inventor at a plurality of stages during a patent prosecution including at least one of a disclosure filing, a U.S. patent application filing, a foreign patent application filing, an allowance of a patent application, and an issuance of a patent.

24. A method in accordance with claim 23 wherein providing a bonus module further comprises providing a bonus module configured to:
display on the client system at least one of a docket number, an invention title, an inventor name, an inventor social security number, an assignment execution date, a docket date, and bonus/awards information; and
prompt a user to enter at least one of bonuses and awards assigned to each inventor at a plurality of stages during a patent prosecution.

25. A method in accordance with claim 23 wherein providing a bonus module further comprises providing a bonus module configured to:
generate at least one report that includes at least one of a docket number, an invention title, an inventor name, an inventor social security number, an assignment execution date, a docket date, and bonus/awards information on a multi-level basis, the multi-level basis includes a plurality of levels from within the business entity including at least one of an individual patent application basis, a product basis, a technology basis, a business basis, a division basis, and a company basis.

26. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information;
providing PA information in response to an inquiry; and
providing at least one report relating to PA information on a multi-level basis to a predesignated party, the multi-level basis includes a plurality of levels from within the business entity including at least one of an individual patent application basis, a product basis, a technology basis, a business basis, a division basis, and a company basis.

27. A method in accordance with claim 26 wherein providing at least one report relating to PA information on a multi-level basis further comprises:
generating at least one of an Attorney Docket Due Report, an MQ15A Report, an MQ15B Report, a Bonus Awards Due Report, an Inventor Log Report, a Patent Portfolio Review Report, a Patent Administrative Record Report (PAR), and an Updated Information for Annuity Payments Report (PAMTAP); and
transmitting to a predesignated party at least one of an Attorney Docket Due Report, an MQ15A Report, an MQ15B Report, a Bonus Awards Due Report, an Inventor Log Report, a Patent Portfolio Review Report, a Patent Administrative Record Report (PAR), and an Updated Information for Annuity Payments Report (PAMTAP).

28. A method in accordance with claim 26 wherein providing at least one report relating to PA information on a multi-level basis further comprises:
generating at least one of a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report; and
transmitting to a predesignated party at least one of a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report.

29. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information; and
providing PA information in response to an inquiry on a multi-level basis selected by a user, the multi-level basis includes a plurality of levels from within the business entity including at least one of an individual patent application basis, a product basis, a technology basis, a business basis, a division basis, and a company basis.

30. A method in accordance with claim 29 wherein updating the centralized database periodically with newly received PA information further comprises enabling a permissioned user to enter newly received PA information through the at least one client system to update the PA information stored in the centralized database, the permissioned user having authority to update PA information relating to a specific level within the business entity assigned to the permissioned user.

31. A method in accordance with claim 29 wherein updating the centralized database periodically with newly received PA information further comprises prohibiting a user from modifying specific PA information stored in the centralized database wherein the specific PA information relates to a specific level within the business entity not assigned to the user.

32. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information;
providing PA information in response to an inquiry;
transmitting at least one report relating to PA information to a predesignated party; and
providing a budget module for managing cost information relating to the business entity's patent assets.

33. A method in accordance with claim 32 wherein providing a budget module for managing cost information further comprises providing a budget module configured to store, track, and process cost information received at the server system that relates to the business entity's patent assets including costs relating to at least one of U.S. filings and foreign filings.

34. A method in accordance with claim 33 wherein providing a budget module for managing cost information further comprises providing a budget module further configured to generate at least one budget on a multi-level basis for the business entity wherein the at least one budget projects patent asset related costs for a selected level within the business entity for upcoming years.

35. A method for managing patent asset (PA) information for a business entity using a server system coupled to a centralized database and at least one client system, said method comprising:
receiving at the server system PA information from the client system;
storing PA information received at the server system in the centralized database;
tracking PA information stored in the centralized database;
updating the centralized database periodically with newly received PA information to maintain PA information;
providing export controls to restrict a user's access to only dockets assigned to the user and to restrict a user's access to only specific information included in a docket assigned to the user; and
providing PA information in response to an inquiry from a user subject to the export controls.

36. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information;
provide PA information in response to an inquiry; and
provide a bonus module for tracking at least one of bonuses and awards assigned to each inventor.

37. A system in accordance with claim 36 wherein said server system is further configured provide at least one report relating to PA information on a multi-level basis to a predesignated party, said multi-level basis includes a plurality of levels from within said business entity including at least one of an individual patent application basis, a product basis, a technology basis, a business basis, a division basis, and a company basis.

38. A system in accordance with claim 37 wherein said server system is further configured to:
generate at least one of an Attorney Docket Due Report, an MQ15A Report, an MQ15B Report, a Bonus Awards Due Report, an Inventor Log Report, a Patent Portfolio Review Report, a Patent Administrative Record Report (PAR), an Updated Information for Annuity Payments Report (PAMTAP), a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report; and
transmit to a predesignated party at least one of said Attorney Docket Due Report, said MQ15A Report, said MQ15B Report, said Bonus Awards Due Report, said Inventor Log Report, said Patent Portfolio Review Report, said Patent Administrative Record Report (PAR), said Updated Information for Annuity Payments Report (PAMTAP), said Patent Applications Filed Report, said Appeal Briefs Filed Report, said Notices of Appeal Report, said Amendments/Responses Report, said Prosecution for Patenting Report, said Pending Applications Report, said Patents Issued Report, said Applications Allowed Report, said Applications Abandoned Report, said Expired Patents Report, said Transferred Patents Report, said Inactivated Dockets Report, said Disclosures Report, said MQ15C Report, said MQ20 Report, said MQ25 Report, said MQ26 Report, said MQ29 Report, said MQ45 Report, said MQ51 Report, said MQ55 Report, said DD882 Information Report, said Deferred Application by Department Report, said Open Actions by Attorney Report, and said Invoice Tracking Report.

39. A system in accordance with claim 36 wherein said server system is further configured to provide PA information in response to an inquiry on a multi-level basis selected by a user, said multi-level basis includes a plurality of levels from within said business entity including at least one of an individual patent application basis, a product basis, a technology basis, a business basis, a division basis, and a company basis.

40. A system in accordance with claim 36 wherein said server system further comprises a budget module for managing cost information relating to said business entity's patent assets, said budget module configured to generate at least one budget on a multi-level basis for said business entity wherein said at least one budget projects patent asset related costs for a selected level within said business entity for upcoming years.

41. A system in accordance with claim 36 wherein said server system is further configured to:
provide export controls to restrict a user's access to only dockets assigned to said user;
provide export controls to restrict a user's access to only specific information included in a docket assigned to said user; and
provide PA information in response to an inquiry from a user subject to said export controls.

42. A system in accordance with claim 36 wherein said server system further comprises a receiving component for receiving an inquiry to provide information from one of a plurality of users.

43. A system in accordance with claim 36 wherein said server system further comprises:
a processing component for generating a schedule of upcoming tasks based on PA information entered through said client system; and
a providing component for transmitting said schedule to a predesignated party.

44. A system in accordance with claim 36 wherein said server system further comprises a receiving component that receives an Inquiry from said client system regarding at least one of a docket number, a docket date, an originating business, a business technology group, an originating lab/technology group, a responsible business, an alternate docket number, a patent application title, a product/part/service description, an abstract, inventor information, prosecuting attorney information, contact information, a disclosure status, a prosecution priority rating, inventor assignment information, foreign filing information, a U.S. Patent and Trademark Office (USPTO) Serial Number, a Patent Number, Group Art Unit data, a recorded date, prosecution tasks, prosecution dates, patent expiration dates, and other information relating to patent assets of said business entity.

45. A system in accordance with claim 36 wherein said server system further comprises a receiving component that:
prompts a user to create a docket, said docket includes at least one of a docket date, an originating business, a business technology group, an originating lab/technology group, a responsible business, an alternate docket number, a title, a product/part/service description, an abstract, comments, a disclosure status, a rating, a contact name, a foreign filing sponsor, a URL name, and a contract type; and
prompts a user to edit a docket stored in said centralized database.

46. A system in accordance with claim 36 wherein said server system further comprises a receiving component for prompting a user to add a filing to a docket stored in said centralized database wherein the filing includes at least one of a provisional patent application, an original patent application, a divisional patent application, and a continuation-in-part patent application.

47. A system in accordance with claim 36 wherein said server system further comprises a receiving component for prompting a user to at least one of:
add a United States filing to a docket wherein the United States filing includes at least one of a serial number, a filing date, a patent number, an issue date, a filing business, a patent owner, a filming type, a filing status, a group art unit, an attorney docket number, a License of Right (LOR), a priority date, a priority country, a title, an abstract, a business method application indicator, recordation information, publication information, contract information, a contract due date, contact name/inventors data, expiration period data, an expiration date, concurrent dockets filed docket number, a filing serial number, and remarks;
add a Foreign filing to a docket wherein the Foreign filing includes at least one of a docket number, a filing country, a docket due date, an originating business, a lab/technology group, a title, an application number, a filing date, a patent number, a patent date, a filing business, a patent owner, a filing type, a filing status, a priority date, a priority country, a title, an Abstract, a License of Right (LOR), a business method application indicator, a publication type, a publication number, a publication date, a publication description, contact data, a contract number, a contract due date, a termination period, and remarks; and
edit a filing associated with a docket stored in said centralized database.

48. A system in accordance with claim 36 wherein said server system further comprises a receiving component for prompting a user to at least one of:
add an action to a docket stored in the centralized database; and
edit an action to a docket stored in the centralized database.

49. A system in accordance with claim 36 wherein said server system further comprises a tracking component for:
tracking at least one of a plurality of dockets, a plurality of filings, and a plurality of actions;
generating a schedule that includes dates and tasks to be performed relating to said plurality of dockets, said plurality of filings, and said plurality of actions; and
transmitting said schedule to a predesignated party.

50. A system in accordance with claim 36 wherein said server system further comprises a providing component for:
displaying information on said client system regarding at least one of a docket, a filing, and an action; and
receiving an inquiry from said client system regarding at least one of a docket, a filing, and an action.

51. A system in accordance with claim 36 wherein said server system and said client system are connected through a network that includes one of a wide area network, a local area network, an intranet and the Internet.

52. A system in accordance with claim 36 wherein said server system further comprises a modular server system, said modular server system configured to communicate with a plurality of other computer systems.

53. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information;
provide PA information in response to an inquiry; and
provide a bonus module to store, track, and process at least one of bonuses and awards assigned to each inventor at a plurality of stages during a patent prosecution including at least one of a disclosure filing, a U.S. patent application filing, a foreign patent application filing, an allowance of a patent application, and an issuance of a patent.

54. A system in accordance with claim 53 wherein said bonus module further comprises a bonus module configured to:
display on said client system at least one of a docket number, an invention title, an inventor name, an inventor social security number, an assignment execution date, a docket date, and bonus/awards information; and
prompt a user to enter at least one of bonuses and awards assigned to each inventor at a plurality of stages during a patent prosecution.

55. A system in accordance with claim 53 wherein said bonus module further comprises a bonus module configured to:
generate at least one report that includes at least one of a docket number, an invention title, an inventor name, an inventor social security number, an assignment execution date, a docket date, and bonus/awards information on a multi-level basis, said multi-level basis includes a plurality of levels from within said business entity including at least one of an individual patent application basis, a product basis, a technology basis, a business basis, a division basis, and a company basis.

56. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information;
provide PA information in response to an inquiry; and
provide at least one report relating to PA information on a multi-level basis to a predesignated party, said multi-level basis includes a plurality of levels from within said business entity including at least one of an individual patent application basis, a product basis, a technology basis, a business basis, a division basis, and a company basis.

57. A system in accordance with claim 56 wherein said server system is further configured to:
generate at least one of an Attorney Docket Due Report, an MQ15A Report, an MQ15B Report, a Bonus Awards Due Report, an Inventor Log Report, a Patent Portfolio Review Report, a Patent Administrative Record Report (PAR), and an Updated Information for Annuity Payments Report (PAMTAP); and
transmit to a predesignated party at least one of an Attorney Docket Due Report, an MQ15A Report, an MQ15B Report, a Bonus Awards Due Report, an Inventor Log Report, a Patent Portfolio Review Report, a Patent Administrative Record Report (PAR), and an Updated Information for Annuity Payments Report (PAMTAP).

58. A system in accordance with claim 56 wherein said server system is further configured to:
generate at least one of a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report; and
transmit to a predesignated party at least one of a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report.

59. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information; and
provide PA information in response to an inquiry on a multi-level basis selected by a user, said multi-level basis includes a plurality of levels from within said business entity including at least one of an individual patent application basis, a product basis, a technology basis, a business basis, a division basis, and a company basis.

60. A system in accordance with claim 59 wherein said server system is further configured to enable a permissioned user to enter newly received PA information through said at least one client system to update PA information stored in said centralized database, said permissioned user having authority to update PA information relating to a specific level within said business entity assigned to said permissioned user.

61. A system in accordance with claim 59 wherein said server system is further configured to prohibit a user from modifying specific PA information stored in said centralized database wherein said specific PA information relates to a specific level within said business entity not assigned to said user.

62. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information; and
provide PA information in response to an inquiry;
transmit at least one report relating to PA information to a predesignated party; and
provide a budget module for managing cost information relating to said business entity's patent assets.

63. A system in accordance with claim 62 wherein said budget module is configured to store, track, and process cost information received at said server system that relates to said business entity's patent assets including costs relating to at least one of U.S. filings and foreign filings.

64. A system in accordance with claim 62 wherein said budget module is configured to generate at least one budget on a multi-level basis for said business entity wherein said at least one budget projects patent asset related costs for a selected level within said business entity for upcoming years.

65. A network based system for managing patent asset (PA) information, said system comprising:
a client system comprising a browser;
a centralized database for storing information; and
a server system configured to be coupled to said client system and said database, said server system further configured to:
receive PA information from said client system;
store PA information in said centralized database;
track PA information;
update said centralized database periodically with newly received PA information to maintain PA information;
provide export controls to restrict a user's access to only dockets assigned to said user and to restrict a user's access to only specific information included in a docket assigned to said user; and
provide PA information in response to an inquiry from a user subject to said export controls.

66. A computer program embodied on a computer readable medium for managing patent asset (PA) information, said program comprising a code segment that receives PA information and then:
maintains a database by adding, deleting and updating PA information;
prompts a user to at least one of create a docket, edit a docket, add a filing, edit a filing, add an action, and edit an action;
provides users with access to PA information;
tracks PA information stored within said database;
provides PA information in response to an inquiry by a user;
provides a schedule of upcoming tasks relating to PA information;
provides at least one report relating to PA information to a predesignated party; and
tracks at least one of bonuses and awards assigned to each inventor.

67. A computer program in accordance with claim 66 further comprising a code segment that provides at least one report relating to PA information on a multi-level basis to a predesignated party, said multi-level basis includes a plurality of levels from within said business entity including at least one of an individual patent application basis, a product basis, a technology basis, a business basis, a division basis, and a company basis.

68. A computer program in accordance with claim 67 further comprising a code segment that:
generates at least one of an Attorney Docket Due Report, an MQ15A Report, an MQ15B Report, a Bonus Awards Due Report, an Inventor Log Report, a Patent Portfolio Review Report, a Patent Administrative Record Report (PAR), an Updated Information for Annuity Payments Report (PAMTAP), a Patent Applications Filed Report, an Appeal Briefs Filed Report, a Notices of Appeal Report, an Amendments/Responses Report, a Prosecution for Patenting Report, a Pending Applications Report, a Patents Issued Report, an Applications Allowed Report, an Applications Abandoned Report, an Expired Patents Report, a Transferred Patents Report, an Inactivated Dockets Report, a Disclosures Report, an MQ15C Report, an MQ20 Report, an MQ25 Report, an MQ26 Report, an MQ29 Report, an MQ45 Report, an MQ51 Report, an MQ55 Report, a DD882 Information Report, a Deferred Application by Department Report, an Open Actions by Attorney Report, and an Invoice Tracking Report; and
transmits to a predesignated party at least one of said Attorney Docket Due Report, said MQ15A Report, said MQ15B Report, said Bonus Awards Due Report, said Inventor Log Report, said Patent Portfolio Review Report, said Patent Administrative Record Report (PAR), said Updated Information for Annuity Payments Report (PAMTAP), said Patent Applications Filed Report, said Appeal Briefs Filed Report, said Notices of Appeal Report, said Amendments/Responses Report, said Prosecution for Patenting Report, said Pending Applications Report, said Patents Issued Report, said Applications Allowed Report, said Applications Abandoned Report, said Expired Patents Report, said Transferred Patents Report, said Inactivated Dockets Report, said Disclosures Report, said MQ15C Report, said MQ20 Report, said MQ25 Report, said MQ26 Report, said MQ29 Report, said MQ45 Report, said MQ51 Report, said MQ55 Report, said DD882 Information Report, said Deferred Application by Department Report, said Open Actions by Attorney Report, and said Invoice Tracking Report.

69. A computer program in accordance with claim 66 further comprising a code segment that provides PA information in response to an inquiry on a multi-level basis selected by a user, said multi-level basis includes a plurality of levels from within said business entity including at least one of an individual patent application basis, a product basis, a technology basis, a business basis, a division basis, and a company basis.

70. A computer program in accordance with claim 66 further comprising a code segment that manages cost information relating to said business entity's patent assets including generating at least one budget on a multi-level basis for said business entity wherein said at least one budget projects patent asset related costs for a selected level within said business entity for upcoming years.

71. A computer program in accordance with claim 66 further comprising a code segment that:
provides export controls to restrict a user's access to only dockets assigned to said user;
provides export controls to restrict a user's access to only specific information included in a docket assigned to said user; and
provides PA information in response to an inquiry from a user subject to said export controls.

72. A computer program in accordance with claim 66 further comprising a code segment that prompts a user to create a docket that includes at least one of a docket date, an originating business, a business technology group, an originating lab/technology group, a responsible business, an alternate docket number, a title, a product/part/service description, an abstract, comments, a disclosure status, a rating, a contact name, a foreign filing sponsor, a URL name, and a contract type.

73. A computer program in accordance with claim 66 further comprising a code segment that:
prompts a user to add a United States filing to a docket wherein the United States filing includes at least one of a serial number, a filing date, a patent number, an issue date, a filing business, a patent owner, a filing type, a filing status, a group art unit, an attorney docket number, a License of Right (LOR), a priority date, a priority country, a title, an abstract, a business method application indicator, recordation information, publication information, contract information, a contract due date, contact name/inventors data, expiration period data, an expiration date, a concurrent dockets filed docket number, a filing serial number, and remarks; and
prompts a user to add a Foreign filing to a docket wherein the Foreign filing includes at least one of a docket number, a filing country, a docket due date, an originating business, a lab/technology group, a title, an application number, a filing date, a patent number, a patent date, a filing business, a patent owner, a filing type, a filing status, a priority date, a priority country, a title, an Abstract, a License of Right (LOR), a business method application indicator, a publication type, a publication number, a publication date, a publication description, contact data, a contract number, a contract due date, a termination period, and remarks.

74. A computer program in accordance with claim 66 further comprising a code segment that:
tracks at least one of a plurality of dockets, a plurality of filings, and a plurality of actions stored within said database; and
generates a schedule that includes dates and tasks to be performed relating to said plurality of dockets, said plurality of filings, and said plurality of actions to facilitate a business entity's compliance with U.S. and Foreign patent laws.

75. A computer program in accordance with claim 74 further comprising a code segment that transmits said schedule to a predesignated party to facilitate management of a plurality of dockets, a plurality of filings, and a plurality of actions stored within said database by the predesignated party.
